(19) United States
(12) Patent Application Publication
(10) Pub. No.: US 2026/0092128 A1
(43) Pub. Date: Apr. 2, 2026

(54) MARINE POLYSACCHARIDE NETWORKS

(71) Applicant: ALBERT LUDWIGS UNIVERSITY OF FREIBURG, Freiburg (DE)

(72) Inventors: Venkatram Prasad SHASTRI, Freiburg (DE); Faycel GHRISSI, Freiburg (DE)

(73) Assignee: ALBERT LUDWIGS UNIVERSITY OF FREIBURG, Freiburg (DE)

(21) Appl. No.: 19/115,131

(22) PCT Filed: Sep. 22, 2023
(86) PCT No.: PCT/US2023/033512

§ 371 Date: Mar. 25, 2025

Related U.S. Application Data
(60) Provisional application No. 63/409,813, filed on Sep. 25, 2022.

(51) Int. Cl. C08B 37/00

(52) U.S. Cl. CPC C08B 37/0084

(57) ABSTRACT

Dual interpenetrating networks of physically-crosslinkable and ionically-crosslinkable marine polymers, where a physically-crosslinkable polymer is physically crosslinked in a manner than entrains an ionically-crosslinkable polymer, and an ionically-crosslinkable polymer is ionically crosslinked in a manner than entrains a physically crosslinkable polymer, are disclosed. Processes for preparing the dual interpenetrating networks, and articles of manufacture including these interpenetrating networks, such as films, laminates, extruded articles, and the like, are also disclosed. In some embodiments, the interpenetrating networks are further subjected to covalent crosslinking.

### FIELD

Double interpenetrating networks of marine polysaccharides, methods for preparing these networks, and articles of manufacture including these networks, are disclosed.

### BACKGROUND

There are many challenges to implementing a sustainable circular economy. Sustainability encompasses renewable and green energy like solar, wind and bio-based fuels and materials that can be sourced from renewable resources. However, there are several limitations associated with conventional bio-plastics, such as polylactic acid, as they possess inferior mechanical/physical and chemical attributes when compared with conventional petroleum-based plastics.

It would be advantageous to provide bio-based plastics with physical and chemical attributes that more closely matched those of conventional petroleum-based plastics. The present invention provides such bio-based plastics, methods for producing these bio-based plastics, and articles of manufacture including these bio-based plastics.

### SUMMARY

Bio-based plastics comprising double interpenetrating, nanostructured networks of marine polysaccharides, methods for producing these bio-based plastics, and articles of manufacture including these bio-based plastics, are disclosed.

In one embodiment, one type of polymer network, which can include one or more polymers, is formed by physical crosslinking. This physical crosslinking can occur due to changes in temperature, the addition of a non-solvent for one or more of the polymers, changes in pH, and combinations thereof. The physical crosslinking is performed in a solution that includes the physically-crosslinkable polymers, and one or more ionically-crosslinkable polymers. As the physical crosslinks occur, the ionically-crosslinkable polymers become entrapped in the physically crosslinked polymer network. The ionically-crosslinkable polymers can then be ionically crosslinked to form a second polymer network. The two networks are entrapped in each other, and are properly characterized as dual interpenetrating networks.

In another embodiment, one type of polymer network, which can include one or more polymers, is formed by physical crosslinking by adding a monovalent cation, such as potassium or sodium, which is not capable of ionically cross-linking the polymer, but which, at a suitable concentration of monovalent cations, and at a suitable temperature, physically gels the polymer. The physical crosslinking is performed in a solution that includes the physically-crosslinkable polymers, and one or more ionically-crosslinkable polymers. As the physical crosslinks occur, the ionically-crosslinkable polymers become entrapped in the physically crosslinked polymer network. The ionically-crosslinkable polymers can then be ionically crosslinked to form a second polymer network. The two networks are entrapped in each other, and are properly characterized as dual interpenetrating networks.

In some aspects of this embodiment, the networks can include additional polymers that can undergo ionic, physical or covalent crosslinking, which allows for the formation of tri, tetra, penta and higher order interpenetrating networks.

In some aspects of this embodiment, the physically-crosslinkable polymers further comprise an ionically crosslinkable group, so can also participate in ionic crosslinking.

In other aspects of this embodiment, one or more of the physically crosslinkable and ionically crosslinkable polymers comprise one or more functional groups that are capable of being covalently crosslinked. After the physical network and ionic network are formed, the covalently-crosslinkable groups can be covalently crosslinked.

As such, the networks are or comprise a double network, one composed of physical crosslinks, and the other of ionic crosslinks. The physical network can be derived from one or more polysaccharides, such as a combination of two different carboxylated agaroses (CAs), two different carrageenans, a CA and a carrageenan, and the like. Where two polymers both undergo physical crosslinks, such as the examples above, CA-CA, CA-carrageenan, carrageenan-carrageenan crosslinks are all possible, and would be stochastic. Any possible combination of two or more of the marine polymers described herein can be used.

In one embodiment where the double-IPN system is further crosslinked by covalent crosslinks, representative covalently crosslinkable groups include free radical polymerizable groups such as (meth)acrylate, or groups capable of being polymerized by condensation polymerization, for example, amine-aldehyde (imine bond formation), reaction of epoxy with amine, and the like. In some aspects of this embodiment, the amine is introduced as part of the physical network or as part another difunctional polymer/oligomer, and the epoxide can be introduced as a diepoxy or other polyepoxy moiety.

In one embodiment, the polysaccharides are marine polysaccharides, which may optionally include one or more additional functional groups, such as ionically-crosslinkable groups, such as carboxylic acids, sulfonic acids, phosphoric acids, phosphinic acids, thiocarboxylic acids, amines and halogens, such as Cl, Br, and I.

In general, the biopolymers useful for forming the double interpenetrating networks include any polymer system that can form independent physical and ionic crosslinks i.e., double interpenetrating networks. While the combination of physical and ionic crosslinks represent two distinct and independent (non-covalently linked) networks, further covalent linkages of the double interpenetrating networks, either to each other, or to other materials, is envisioned. As discussed above, in some embodiments, the double interpenetrating networks comprise physical crosslinks derived from two different polymers. For example, the crosslinks can be between two carboxylated agarose polymers, two carrageenans, or a combination of a carboxylated agarose polymer and a carrageenan, such as a kappa carrageenan.

Representative polymers include agarose (A) and its ionically-crosslinkable derivatives, such as carboxylated derivatives (CA), carrageenans (including Kappa, Iota, and the like), other hydrocolloids, i.e., polysaccharides that can undergo physical gelation, and polysaccharides derived from salt water or fresh water algae, such as Chaetamorpha (non-limiting examples of which include Chaetomorpha linum, Chaetomorpha aerea, and Chaetomorpha antennina).

Additional representative polymers include those described in Marco Beaumont, Remy Tran, Grace Vera, Dennis Niedrist, Aurelie Rousset, Ronan Pierre, V. Prasad Shastri, and Aurelien Forget, “Hydrogel-Forming Algae Polysaccharides: From Seaweed to Biomedical Applications, Biomacromolecules 2021 22(3), 1027-1052 DOI: 10.1021/acs.biomac.0c01406, the contents of which are hereby incorporated by reference. For example, in addition to agarose, the networks can include alginates, carrageenans, ulvan, starches, porphyrans, celluloses and analogs thereof (such as methyl cellulose, ethyl cellulose, hydroxypropylcellulose, and the like), as well as (nano)cellulose, including cellulose nanocrystals/nano-crystalline cellulose.

Additional polymers include those formed by normal and thermophilic bacteria. Representative polymers include exocellular polysaccharides produced by lactic acid bacteria, as disclosed, for example, in “Jutta Cerning, Exocellular polysaccharides produced by lactic acid bacteria,” FEMS Microbiology Reviews, Volume 7, Issue 1-2, September 1990, Pages 113-130, Lactic acid bacteria produce homopolysaccharides (dextrans and mutans) and heteropolysaccharides. Mutans streptococci, which include Streptococcus mutans and S. sobrinus, produce soluble and insoluble α-glucans. The latter may contain as much as 90% α-1-3 linkages. Dextrans produced by Leuconostoc mesenteroides are high molecular weight α-glucans having 1-6, 1-4 and 1-3 linkages, varying from slightly to highly branched; 1-6 linkages are predominant. These polysaccharides tend to include galactose and glucose moieties.

Examples also include polysaccharides from extremophilic microorganisms (see, for example, Nicolaus et al., “Polysaccharides from extremophilic microorganisms,” Origins of life and evolution of the biosphere, Vol. 34, pages 159-169 (2004) and Nicolaus et al., “Polysaccharides from Extremophilic Microorganisms,” Origins of Life and Evolution of Biospheres, 34(1-2):159-69 (2004)). Nicolaus identified four polysaccharides from thermophilic marine bacteria, with complex primary structures and with different repetitive units: a galacto-mannane type from strain number 4004 and mannane type for the other strains. The thermophilic Bacillus thermantarcticus produces two exocellular polysaccharides (EPS 1, EPS 2) that give the colonies a typical mucous character. EPS 1 is a heteropolysaccharide, of which the repeating unit is constituted by four different α-D-mannoses and three different β-D-glucoses, and is similar in structure to some xantan polymers. EPS 2 is a mannan, with four different α-D-mannoses found as the repeating unit. Four different alpha-D-mannoses were found as the repeating unit. Marine biopolymers are also produced by halophilic archaea, Haloarcula species.

Analogs of these polymers, including carboxylated, phosphated (phosphorylated), sulfonated, sulfated, halogenated, and aminated analogs of these polymers, can also be used.

Suitable polymers also include polymers that include amine salts, e.g., polymers containing ethyleneimine, lysine, imidazole, and the like, as well as other water-soluble polymers that bear such amine salts. Such polymers can be crosslinked, for example, using di-, tri-, or polycarboxylic acids.

The term “double interpenetrating network”, as used herein, refers to a combination of physical crosslinks and ionic crosslinks. While any physical crosslinks can be used, there are four main gelation mechanisms in marine polysaccharides, such as algal polysaccharides. These include complexation in ionic polysaccharides, such as alginates, aggregation of polysaccharide chains into secondary structures through formation of double helices, formation of physical cross-links by induced crystallization in amorphous regions, and gelation of colloids, such as nanocellulose, by colloidal crowding. Combinations of these approaches can also be used.

Once the polymers have been physically crosslinked, they are then ionically crosslinked, for example, using di-, tri-, or polyvalent metal ions, or other ionic crosslinking groups, as described herein. For example, depending on the functionality of the marine polymers, the polymers can be ionically-crosslinked together using any suitable metal ion, such as Ca(2+), Zn(2+), Cu(2+), Sr(2+), Ba(2+), Fe(2+ and 3+), or other divalent or trivalent cationic species.

The ionic crosslinking can also be carried out with divalent or polyvalent species, such as cationic polymers. Representative cationic polymers include polyethyleneimine, polylysine, polyimidazole or other polymers comprising these amine groups. In some embodiments, the cationic polymers are water-soluble.

The double interpenetrating networks can further be covalently crosslinked, where the crosslinks are between the polymers forming the networks and/or to objects to which the polymer networks are adhered/coated. To the extent the polymers are further covalently crosslinked, representative crosslinking agents include di and tri-epoxies of polyhydric alcohols, such as ethylene glycol, propylene glycol, diethylene and triethylene and tetra ethylene (glycol), as well as oligomeric and polymeric ethylene glycols, as well as polyethylene oxide (PEO) and PEG di-epoxides. Those polymers with hydroxy/phenol groups can also be linked, for example, using isocyanates, including di-, tri-, and oligomeric isocyanates, to form urethane linkages.

Click chemistry can also be used to perform covalent linkages. Click chemistry typically is performed at or near biological conditions, produces little and (ideally) non-toxic byproducts, has (preferably) single and stable products at the same conditions, and proceeds quickly to high yield in one pot. Existing reactions, such as Staudinger ligation and the Huisgen 1,3-dipolar cycloaddition, have been modified and optimized for such reaction conditions. Representative examples of click chemistry include [3+2]cycloadditions, such as the Huisgen 1,3-dipolar cycloaddition, in particular the Cu(I)-catalyzed stepwise variant, the thiol-ene reaction, Diels-Alder and inverse electron demand Diels-Alder reactions, [4+1]cycloadditions between isonitriles (isocyanides) and tetrazines, nucleophilic substitution, especially to small strained rings like epoxy rings and aziridines, carbonyl-chemistry-like formation of ureas, thioureas, and the like, and addition reactions to carbon-carbon double bonds, such as dihydroxylation, or the alkynes in the thiol-yne reaction. Additional representative examples include copper(I)-catalyzed azide-alkyne cycloaddition (CuAAC), strain-promoted azide-alkyne cycloaddition (SPAAC), strain-promoted alkyne-nitrone cycloaddition (SPANC), reactions of azides and amines, and reactions of strained alkenes.

To the extent free radical polymerization is used to covalently cross-link the polymer networks, the polymers can include olefinic groups, which can be cross-linked with di, tri-, and oligomeric olefin-containing groups, such as (meth)acrylates, vinyl esters, vinyl ethers, vinyl sulfones, vinyl sulfonates, thiol-enes, cycloalkenes, such as cyclooctene, and the like. The free-radical polymerization can be performed using light-curing techniques, and/or using chemical free radical initiators such as t-butyl peroxide, cumyl peroxide, AIBN, and/or gamma radiation, heat and the like. Water-soluble and water-dispersible photoinitiators, such as lithium phenyl-2,4,6-trimethylbenzoylphosphinate (LAP) and water-dispersible photoinitiator nanoparticles of diphenyl(2,4,6-trimethylbenzoyl)phosphine oxide (TPO) can also be used. Redox polymerization, for example, using ferrous sulfate and tetraethylene diamine, can also be used to initiate free radical polymerization. A combination of a dye and an amine can be exposed to visible light to generate free radicals, and this technique can also be used to initiate free radical polymerization.

The polymer networks can be “filled” polymers, where various additives are present in the films, laminates, or other articles of manufacture. The fillers can be, for example, antimicrobial agents, such as ionic liquids, metal colloids, copper and silver colloids and salts, antimicrobial peptides, quaternary ammonium salts, and cationic polymers (so long as the cationic polymers do not disrupt the networks.

Additional fillers include clay, laponite, silicates, talc, graphene, carbon colloid, C60, nanotubes (carbon and metals), metal “whiskers,” including nano-whiskers, glass fibers, wood powder, saw dust, silica colloids, nano-cellulose (nanocrystalline cellulose), and the like.

The polymer networks can be used to create articles of manufacture, such as films, laminates, surface coatings for wood, metals, plastics, and the like, articles prepared using molding techniques, such as extrusion molding, and the like.

In one embodiment, when used to prepare articles of manufacture, the materials can be prepared using 3D printing.

In another embodiment, natural materials can be fabricated with surfaces comprising one or more of the polymer networks described herein, such as a double interpenetrating network of carboxylated agarose/aginate or alginic acid (CAAlg). The surfaces can be activated, and subsequently bonded, for example, using a solution of metal ions capable of ionically crosslinking the polymers. In one embodiment, the metal ions are or comprise calcium ions.

The present invention will be better understood with reference to the following detailed description.

### BRIEF DESCRIPTION OF THE DRAWINGS

FIG. 1A is a schematic illustration of the guiding principles for the engineering of the double-interpenetrating network, showing a schematic representation of the double-interpenetrating network of physical and ionically-crosslinked polymers.

FIG. 1B is a (i) Schematic illustration of the “casting from” strategy of the polysaccharide-based composite. (ii) Photograph of a CAAlg composite film placed in front of a logo of the Institute for Macromolecular Chemistry illustrating its transparent characteristics.

FIGS. 2A-F are scanning electron micrographs (SEMs) of cross sections of freeze-dried 5% (w/v) CA, Alg and 500 mM CAAlg Films.

FIGS. 2G-I are atomic force height images of air-dried 5% (w/v) CA, Alg and 500 mM CAAlg films, showing that CAAlg composite films show discrete domains.

FIG. 2K is a table summarizing various physical properties (E (GPa), σ (Pa), ε (%), and U_{T}(MJ/m³) of various films, including Ca, CAAlg* and CAAlg-500 films. The asterisk represents films that have not been crosslinked.

FIGS. 3A-E are atomic force microscopy (AFM) height images of 5% (w/v) dried films processed using varying concentrations of calcium chloride. Surface topography, quantitatively described here as root mean square (Rq) roughness, provides evidence for the evolving nano-scale domains, and shows that the evolution of nano-scale domains can be controlled by calcium content.

FIGS. 3E-F are scanning electron micrographs (SEM micrographs) of cross-section of 5% (w/v) freeze-dried films showing the presence of nano-domains in the bulk of the film. k) Control over nano-domain size by varying calcium concentration.

FIG. 3G is a chart showing the average domain size (M) versus calcium concentration (mM) for a series of films, showing that control over nano-domain size can be obtained by varying calcium concentration.

FIGS. 4A-G show that CAAlg composites films possess mechanical properties comparable to petroleum-based plastics.

FIG. 4A is a chart showing the stress-strain behavior in 5% w/v CAAlg films as a function of [Ca2+] during the ionic crosslinking step, as a function of σ (MPa) versus strain (%).

FIGS. 4B-4D are charts showing the Young's modulus (E, GPa), ultimate tensile strength (UTS, MPa)), and toughness (UT, Mj/m³) of CAAlg films as function of calcium ion concentration, respectfully.

FIG. 4E is a chart showing fracture strain (ε at break, %) versus calcium ion concentration, revealing a positive correlation with [Ca2+] concentration during crosslinking.

FIG. 4F is a chart showing the average σ_{y}, MPa versus average domain size (m) in CAAlg composites, showing that the average domain size can be associated with yielding behavior in CAAlg films.

FIG. 4G is an Ashby plot depicting the property profile of CAAlg films in comparison to some natural materials, double network (DN) hydrogels (45), and synthetic plastics used in consumer products (EVA: ethylene vinyl acetate, LDPE: low density polyethylene, HDPE: high density polyethylene, PBT: polybutylene terephthalate, PET: polyethylene terephthalate, PHB: poly(hydroxybutyrate), PLA: polylactic acid, PMMA: polymethyl methacrylate)). Data for the synthetic plastics, composites and natural materials were obtained from www.matweb.com.

FIGS. 5A-E show that CAAlg films can be processed into laminated structures through wet ionic bonding.

FIG. 5A is schematic illustration of one embodiment of the preparation of laminated structures of CAAlg composites through surface-activated molecular bonding via calcium crosslinking of Alg chains. In this embodiment, the fabrication route produces 3-ply (3-layered) composite films.

FIG. 5B is a photograph of the laminated film produced using the process shown in FIG. 5A.

FIG. 5C is a schematic illustration of an embodiment of a lap shear test setup for determining adhesion properties between bonded CAAlg films interface.

FIG. 5D is a photograph of a 2-ply laminated CAAlg film sandwiched between glass slides supporting a weight without undergoing catastrophic failure at the bonded interface.

FIG. 5E is a chart showing a representative lap shear test curve (Force, N versus displacement, %) in tensile mode, revealing that the newly formed interface between CAAlg films is physicochemically identical to the bulk of the CAAlg composite.

FIGS. 6A-G show the processing of CAAlg into films and interfaces in the fabrication of wood laminate.

FIG. 6A is a photograph of a film of CAAlg printed using extrusion printing. FIG. 6B is a photograph showing the crosslinking of the film with Ca2+ to yield mechanical stable films. FIG. 6C is a photograph showing, in contrast to crosslinked films, a film of CAAlg without Ca2+ crosslinking, showing that the film lacked physical integrity and could not be handled, providing clear evidence for the importance of the ionic crosslinking in imparting mechanical properties to the film. FIG. 6D is a photograph showing the printing of a film with a rectilinear grid pattern. FIG. 6E is a photograph of a dried film of a 3-layered crisscross construct fabricated by wet-bonding of calcium-crosslinked CAAlg films immediately after printing, and FIG. 6F is a photograph of the rehydrated film, showing the stability of the bonded layers. The film remained bonded in water even after 72 h.

FIG. 6G is a schematic illustration of the fabrication of a wood-CAAlg composite. The process workflow involves printing of pattern of lines on the wood surface, followed by calcium crosslinking of the pattern, and room temperature drying of the wood CAAlg composite, with photographs showing wood panels following printing and crosslinking. The fabrication of 2-ply wood laminates involves two key steps, namely, activation and bonding under pressure. The photographs show a 2-play wood laminate bonded via a rectilinear grid interface of CAAlg-150 composite. The wood panels were affixed to a glass slide using two-sided tape for handling purposes.

FIG. 7 is a photograph of an air-dried 5% (w/v) 150 mM calcium crosslinked alginic acid film.

FIG. 8 is a chart showing the thermogravimetric analysis (TGA) for CAAlg-150 samples, as a function of weight loss (%), temperature (° C.), and deriv. weight (%).

FIGS. 9A and 9B are SEM micrographs and AFM height images of 5% (w/v) non-crosslinked CAAlg air-dried films.

FIGS. 10A-C are ESEM micrographs of 5% (w/v) CAAlg-150 gel with different chamber pressures, showing height (μm) versus pressure (Pa).

FIG. 11 is a chart showing the rheological properties of a 1 w/v % CA blend, as a function of modulus (G′, G″, Pa) versus frequency (f, Hz) of a 1% (w/v) CA solution in absence of calcium (filled symbols) and in presence of 150 mM [Ca2+](CA*, open symbols), showing that the addition of calcium has negligible impact on the rheological properties of CA.

FIG. 12 is a photograph showing a series of AFM images of CAAlg film surfaces after stretching, showing the deformation and elongation (in nm) of the nano-domains.

FIG. 13 is a chart showing a comparison of four different main gelation mechanisms in algal polysaccharides, including complexation in ionic polysaccharides, such as alginates, aggregation of polysaccharide chains into secondary structures through a formation of double helices, formation of physical cross-links by induced crystallization in amorphous regions, and gelation of colloids, such as nanocellulose, by colloidal crowding.

FIG. 14 is a schematic illustrationof one embodiment of a process for producing a modified carboxylated agarose (CA) comprising one or more covalently-crosslinkable groups.

FIGS. 15A and 15B are 1H NMR spectra for CA (blue) and CA-APS (red).

FIGS. 16A and 16B are 2D NMR spectra for CA (blue) and CA-APS (red).

FIGS. 17A and 17B are GPC data of CA (blue) and 50% modified CA-APS (red).

FIGS. 18A and 18B are EDX Spectroscopy data of CA (18A) and 50% modified CA-APS (18B).

FIGS. 19A-C are charts showing Young's modulus (Et/MPa), ultimate tensile strength (UTS/MPa) and strain (Strain/%) for κ-carrageenan/alginate films physically crosslinked with 60 mM KCl, and ionically crosslinked with varying concentrations of calcium ions (CaCl₂, mM). Data points where the ratio of κ-carrageenan/alginate is 1/1 is shown with circles, 3/2 with squares, and 3/1 with triangles.

FIGS. 20A-C are charts showing Young's modulus (Et/MPa), ultimate tensile strength (UUTS/MPa) and strain (Strain/%) for κ-carrageenan/alginate films physically crosslinked with 70 mM KCl, and ionically crosslinked with varying concentrations of calcium ions (CaCl₂, mM). Data points where the ratio of κ-carrageenan/alginate is 1/1 is shown with circles, 3/2 with squares, and 3/1 with triangles.

FIGS. 21A-C are charts showing Young's modulus (Et/MPa), ultimate tensile strength (UTS/MPa) and strain (Strain/%) for κ-carrageenan/alginate films physically crosslinked with 80 mM KCl, and ionically crosslinked with varying concentrations of calcium ions (CaCl₂, mM). Data points where the ratio of κ-carrageenan/alginate is 1/1 is shown with circles, 3/2 with squares, and 3/1 with triangles.

FIG. 22 is a chart showing the Young's Modulus (Et/MPa) for κ-carrageenan/alginate films physically crosslinked with varying concentrations of KCl, and ionically crosslinked with varying concentrations of calcium ions (CaCl₂, mM).

FIG. 23 is a chart showing the universal tensile strength (UTS/MPa) for κ-carrageenan/alginate films physically crosslinked with varying concentrations of KCl, and ionically crosslinked with varying concentrations of calcium ions (CaCl₂, mM).

FIG. 24 is a chart showing the strain (Strain/%) for κ-carrageenan/alginate films physically crosslinked with varying concentrations of KCl, and ionically crosslinked with varying concentrations of calcium ions (CaCl₂, mM).

FIG. 25 is a chart showing the elastic modulus (Et/MPa) with varying concentrations of calcium ions (CaCl₂, mM) and potassium ions (KCl, mM).

FIG. 26 is a chart showing the stress (stress/MPa) with varying concentrations of calcium ions (CaCl₂, mM) and potassium ions (KCl, mM).

### DETAILED DESCRIPTION

Double interpenetrating networks of marine biopolymers are disclosed. In one embodiment, one type of polymer network, which can include one or more polymers, is formed by physical crosslinking. This physical crosslinking can occur due to changes in temperature, the addition of a non-solvent for one or more of the polymers, changes in pH, and combinations thereof. The physical crosslinking is performed in a solution that includes the physically-crosslinkable polymers, and one or more ionically-crosslinkable polymers. As the physical crosslinks occur, the ionically-crosslinkable polymers become entrapped in the physically crosslinked polymer network. The ionically-crosslinkable polymers can then be ionically crosslinked to form a second polymer network. The two networks are entrapped in each other, and are properly characterized as dual interpenetrating networks.

In some aspects of this embodiment, the physically-crosslinkable polymers further comprise an ionically crosslinkable group, so can also participate in ionic crosslinking.

In another embodiment, one type of polymer network, which can include one or more polymers, is formed by physical crosslinking by adding a monovalent cation, such as potassium or sodium, which is not capable of ionically cross-linking the polymer, but which, at a suitable concentration of monovalent cations, and at a suitable temperature, physically gels the polymer. The physical crosslinking is performed in a solution that includes the physically-crosslinkable polymers, and one or more ionically-crosslinkable polymers. As the physical crosslinks occur, the ionically-crosslinkable polymers become entrapped in the physically crosslinked polymer network. The ionically-crosslinkable polymers can then be ionically crosslinked to form a second polymer network. The two networks are entrapped in each other, and are properly characterized as dual interpenetrating networks.

In other aspects of this embodiment, one or more of the physically crosslinkable and ionically crosslinkable polymers comprise one or more functional groups that are capable of being covalently crosslinked. After the physical network and ionic network are formed, the covalently-crosslinkable groups can be covalently crosslinked.

As such, the networks are or comprise a double network, one composed of physical crosslinks, and the other of ionic crosslinks, though tri, tetra, penta and higher orders of interpenetrating networks are contemplated.

The physical network can be derived from one or more polysaccharides, such as a combination of two different carboxylated agaroses (CAs), two different carrageenans, a CA and a carrageenan, and the like. Where two polymers both undergo physical crosslinks, such as the examples above, CA-CA, CA-carrageenan, carrageenan-carrageenan crosslinks are all possible, and would be stochastic. Any possible combination of two or more of the marine polymers described herein can be used.

In one embodiment where the double-IPN system is further crosslinked by covalent crosslinks, representative covalently crosslinkable groups include free radical polymerizable groups such as (meth)acrylate, or groups capable of being polymerized by condensation polymerization, for example, amine-aldehyde (imine bond formation), reaction of epoxy with amine, and the like. In some aspects of this embodiment, the amine is introduced as part of the physical network or as part another difunctional polymer/oligomer, and the epoxide can be introduced as a diepoxy or other polyepoxy moiety.

In a further embodiment, where the networks can be formed using combinations of physically-crosslinkable, ionically-crosslinkable, and, optionally, covalently-crosslinkable polymers, the physical crosslink is first established, and the ionic and covalent crosslinks are established after the physical crosslink, though in either order.

In a further embodiment, where the networks can be formed using combinations of physically-crosslinkable, ionically-crosslinkable, and, optionally, covalently-crosslinkable polymers, the covalent crosslink is first established, and the ionic and physical crosslinks are established after the covalent crosslink, though in either order.

In a further embodiment, where the networks can be formed using combinations of physically-crosslinkable, ionically-crosslinkable, and, optionally, covalently-crosslinkable polymers, the ionic crosslink is first established, and the covalent and physical crosslinks are established after the ionic crosslink, though in either order.

The double interpenetrating networks, methods of making them, and methods of using them, will be better understood with reference to the following detailed description and figures.

### I. Marine Polymers

Representative marine polymers are shown in the following table:

TABLE 1

[symbol]

| | | | |
|---|---|---|---|
| Name | Chemical composition | General structure | Phylum |

Complex

[symbol]

| | | | |
|---|---|---|---|
| Alginsie | β-D-mannuronate α-L-guluronate | 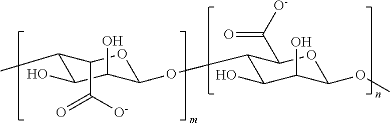 | [symbol] chroph [symbol] |
| A-Carrag [symbol] | β-D-galactose α-D-galactose | 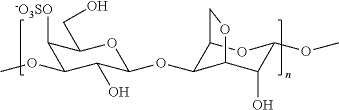 | Rhodophyta |
| Ul [symbol] | β-D-glucuronic/ α-L-i [symbol] nic acid α-L-rhamnose | 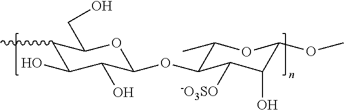 | Chlorophyt [symbol] |

Cyrstalization

| | | | |
|---|---|---|---|
| Starch (Amylose) | α-D-glucose | 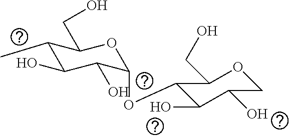 [SMILES: CC1C(CO)OC(OC2C(CO)OCC(O)C2O)C(O)C1O] | Chlorophyt [symbol] Rhodophyta |

Formulation of secondary structure

| | | | |
|---|---|---|---|
| Agarose | β-D-galactose 3,6 anhydro- α-L-galactose | 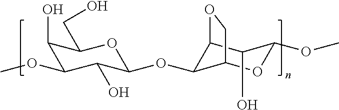 | Rhodophyta |
| [symbol] -Carrag [symbol] nan | β-D-galactose 3,6-anhydro- α-D-galactose | 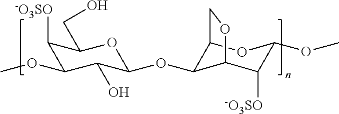 | Rhodophyta |
| Porphyran | β-D-galactose 3,6-anhydro- α-L-galactose | 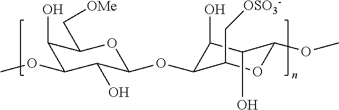 | Prophyra |

Co [symbol] assembly

| | | | |
|---|---|---|---|
| Cellulose | β-D-glucose | 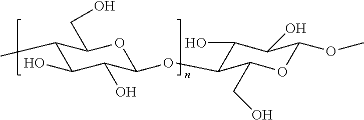 | Chlorophyt [symbol] [symbol] chrophyta |

[symbol]

indicates data missing or illegible when filed

Additional polymers include those disclosed in Rhein-Knudsen, et al., “Seaweed Hydrocolloid Production: An Update on Enzyme Assisted Extraction and Modification Technologies,” Mar. Drugs 2015, 13(6), 3340-3359.

Agar, alginate, and carrageenans are high-value seaweed hydrocolloids, which are used as gelation and thickening agents in different food, pharmaceutical, and biotechnological applications. The techno-functional properties of the seaweed polysaccharides depend strictly on their unique structural make-up, notably degree and position of sulfation and presence of anhydro-bridges. Classical extraction techniques include hot alkali treatments, but recent research has shown promising results with enzymes. Current methods mainly involve use of commercially available enzyme mixtures developed for terrestrial plant material processing. Application of seaweed polysaccharide targeted enzymes allows for selective extraction at mild conditions as well as tailor-made modifications of the hydrocolloids to obtain specific functionalities.

Hydrocolloids can be defined as substances that interact with water to form colloid systems either in the form of a gel or a sol system of solubilized particles. In practice, the viscosity of the system will generally increase as a result of the interaction between the hydrocolloid and water. Hydrocolloid polysaccharides have significant importance, both technologically and economically, since they are used in the food, pharmaceutical, medicinal, and biotechnological industries due to their distinct physico-chemical properties. The currently used hydrocolloid polysaccharides are derived from plant, microbial, and seaweed sources: pectin is, for example, extracted from apple pomace and citrus peel; xanthan gum is prepared by aerobic fermentation from Xanthomonas campestris, and agar, alginates, and carrageenans are obtained from brown and red seaweeds.

The chemistry, properties, and applications of the three seaweed-derived hydrocolloids, carrageenans, agar, and alginate, are discussed below. Enzyme technology can be used for extractions and modifications of these polymers. The use of enzymes, moreover, allows for reduction of chemicals in seaweed hydrocolloid extraction and thus holds enormous potential for creation of sustainable processing of seaweed polysaccharides.

### Carrageenans

Commercial carrageenans are extracted from the carrageenophyte red seaweed genera Kappaphycus, Gigartina, Eucheuma, Chondrus, and Hypnea, in which the carrageenans comprise up to 50% of the dry weight. κ-Carrageenan is mostly extracted from Kappaphycus alvarezii, known in the trade as Eucheuma cottonii, while ι-carrageeman is predominantly produced from Eucheuma denticulatum, also known as Eucheuma spinosum. λ-Carrageenan is obtained from seaweeds within the Gigartina and Chondrus genera, which as sporophytic plants produce λ-carrageenan while they make a κ/ι-hybrid as gametophytic plants.

### Carrageenan Chemical Structure

Carrageenans are hydrophilic sulfated linear galactans that mainly consist of d-galactopyranose units bound together with alternating α-1,3 and β-1,4 linkages. This base structure is consistent in the three main commercially used carrageenans, κ-, ι-, and λ-carrageenan. The presence of 4-linked 3,6-anhydro-α-d-galactopyranose varies among the different carrageenans, as do the substitutions with sulfates, which are ester-linked to C2, C4, or C6 of the galactopyranose units, depending on the specific carrageenan: κ-, ι-, or λ-carrageenan. κ-Carrageenan has one sulfate ester, while ι- and λ-carrageenan contain two and three sulfates per dimer, respectively. In addition, the galactopyranose units may also be methylated or substituted with e.g., monosaccharide residues, such as d-xylose, 4-O-methyl-l-galactose, and d-glucuronic acid. Acid hydrolysis, infrared spectroscopy, and NMR analyses of commercial carrageenan typically show sulfate content of 25%-30% for κ-carrageenan, 28%-30% for ι-carrageenan, and 32%-39% for λ-carrageenan, although large differences can occur. The differences in sulfate levels are explained by the fact that carrageenans are very heterogeneous carbohydrates, with structural differences coexisting within the specific type of carrageenan depending on the algal source, life-stage, and extraction method. In addition, naturally occurring carrageenans contain traces of their biosynthetic precursors, μ- and ν-carrageenan, adding further to the complexity of these polysaccharides. Hybrid carrageenans exist, representing a mixture of the different carrageenan repeating units.

### Physico-Chemical Properties of Carrageenans

Carrageenans are soluble in water, but the solubility depends on the content of hydrophilic sulfates, which lowers the solubility temperature, and the presence of potential associated cations, such as sodium, potassium, calcium, and magnesium, which promote cation-dependent aggregation between carrageenan helices. Another factor affecting the physico-chemical properties in relation to viscosity and gelation is the presence of anhydro-bridges: κ- and ι-carrageenans have 3,6-anhydro-galactopyranose units, while λ-carrageenan is composed exclusively of α-1,3 galactopyranose and β-1,4 galactopyranose.

The presence of anhydro-bridges in κ- and ι-carrageeenan is proposed to be a result of elimination of a sulfate ester present on their respective precursors, i.e., in μ- and ν-carrageenan, and subsequent spontaneous anhydro-bridge formation in the desulfated monomer residue. The removal of the sulfate esters in μ- and ν-carrageenan reduces the hydrophilicity of the sugar residue and inverts the chair conformation from 1C4 to 4C1. The conformation change allows the polysaccharide to undergo conformational transitions which are conducive to the gelation properties of the anhydro-bridge containing carrageenans.

The thermo-reversible gel formation is proposed to occur in a two-step mechanism, dependent on temperature and gel-inducing agents. At high temperatures, i.e., above 75-80° C., the carrageenans exist as random coil structures as a result of electrostatic repulsions between adjacent polymer chains. Upon cooling, the polymeric chains change conformation to helix structure. Further cooling and presence of cations (K+, Ca2+, Na2+) lead to aggregation of the helical dimers and formation of a stable three dimensional network, which forms through intermolecular interactions between the carrageenan chains. The molecular details of carrageenan gelation are still uncertain. The formation of double helices prior to gelation is not fully proven, and, in principle, the formation of a duplex via chain-chain interactions may not necessarily be an unequivocal evidence for double helix formation. Nevertheless, based on the available literature data and theoretical explanations, for the stiff κ-carrageenan gels to form, the cations, typically potassium for κ-carrageenan, function to stabilize the junction zones between the two helixes by binding to the negatively charged sulfate groups without hindering cross-linking of the two helices. According to this model, calcium, typically for ι-carrageenan, analogously function to cross-link the two helices through ionic salt bridges. The charged sulfate esters on the other side of the monomer though, present on ι-carrageenan, encourage an extensive conformation via a repulsion effect of the negative SO₃⁻ groups and inhibit gelation while promoting viscosity in the solution. The differences in sulfate position, their proportion, and the presence of anhydro-bridges, thus, give the carrageenans distinctive gel profiles: κ-carrageenan forming strong and rigid gels, ι-carrageenan forming soft gels, and λ-carrageenan that does not gel, but still provides elevated viscosity in solution, due to a structure that does not allow helix formation. Natural carrageenans are heterogenous, i.e., have heteropolymeric structures. In practice, the rheological properties of carrageenans reflect that hybrid structures exist.

### Enzymatic Extraction of Carrageenans

Carrageenans are produced as semi-refined or refined carrageenans. In the production of semi-refined carrageenans, the carrageenans are not extracted from the seaweed, but instead heated (to around 75° C.) with an alkaline solution of potassium hydroxide. The hydroxide reacts with the sulfate esters at the precursors μ- and ν-carrageenan to produce κ- and ι-carrageenan, which improves the gel strength of the product, while potassium binds to the carrageenans and promotes gel formation by preventing the hydrocolloid chains from dissolving. The seaweed containing the potassium bound carrageenan is washed, dried, and minced to powder. When producing refined carrageenans, the process of semi-refined carrageenan extraction is continued further by heating (95-110° C.) the alkali treated seaweed in order to dissolve the gel matrix in the seaweed frond. The carrageenans are recovered by alcohol precipitation or gel pressing. The polysaccharides can also undergo degradation under severe conditions like pressure extraction, high temperatures, and high alkali concentrations.

The literature reports several examples of enzymatic extraction of carrageenans from red seaweed. Carrageenan can be produced using an alcalase (a commercially available protease) to extract a κ/ι-hybrid from Mastocarpus stellatus. Hybrid carrageenans may be selectively extracted using enzymes, and enzymes may allow for targeted production of specific gelation properties since hybrid carrageenans may exhibit unique, desirable physical properties. ι-carrageenan can be extracted from Soliera filiformis by use of papain (a protease derived from papaya fruits) or using hot water. A carrageenan can be extracted from Eucheuma cottonii using a cellulase or hot water The viscosity of the cellulase-extracted carrageenan tends to be lower than those extracted using hot water. Fungal treatment of the seaweed with A. niger results in the extraction of low viscosity carrageenans, most likely because the organism may have used the carrageenans as carbon source.

When extracting carrageenans by enzymatic reactions, the precursors μ- and ν-carrageenan have to be converted into κ- and ι-carrageenan to obtain a purer product with better gelling abilities. Sulfurylases can be used to convert ν-carrageenan into ι-carrageenan, and convert μ-carrageenan into κ-carrageenan.

Intensive research has been conducted on the hydrolysis of carrageenans, for example, using the marine bacterium Pseudoalteromonas carrageenovora and the enzymes produced by this organism. From this bacterium, one can purify κ-carrageenase (EC 3.2.1.83) responsible for cleavage of the β-1,4 linkages, belonging to the glycoside hydrolase (GH) 16 family, along with several β-agarases responsible for the degradation of agarose ι-carrageenase (EC 3.2.1.157) can be purified from Zolbellia galactanivorans. The enzyme belongs to GH family 82 along with other reported ι-carrageenase. Another carrageenase has been isolated from P. carrageenovora, but this enzyme acts only on λ-carrageenan.

Digestion by carrageenases generates oligo-galactans of various sizes, most likely carbohydrates with a degree of polymerization (DP) of 2, 4, and 6. The reason for the production of different DPs is a result of the heterogenous carrageenan structure and the mechanisms that the enzymes follow. The alternating α-1,3 and β-1,4 linkages in the carrageenans results in successive β-1,4 linkages to be in opposite orientations and hence only every second disaccharide is in the right position for cleavage. The three carrageenases all have an endo-lytic mode of action, in which they act on linkages in the middle of the chains, resulting in the formation of DP6s. The main products from κ- and ι-carrageenase digestion are DP4s and DP2s, indicating a processive mechanism, in which the enzyme does not dissociate from the substrate and instead slides along the polysaccharide, cleaving all possible bonds. The tunnel-shaped active sites, found in both κ- and ι-carrageenases, further indicate a processive mechanism, where the substrate is enclosed in the active site of the enzyme. This processive behavior favors the formation of DP4s and DP2s. λ-Carrageenase on the other hand, proceeds in a more random manner, resulting in higher amounts of DP6s (and possible other higher DPs as products) compared to the products from κ- and ι-carrageenase hydrolysis. Enzymes responsible for converting smaller carrageenan oligosaccharides have been reported for κ-carrageenan DP4, which is converted into κ-carrageenan DP2 by a carratetraose 4-O monosulfate β-hydrolase. The molecular mechanism for hydrolysis of the β-1,3 bonds differs between the different carrageenases. Hence, κ-carrageenases retain the anomeric configuration, while ι- and λ-carrageenases invert the anomeric. Carrageenases appear to recognize the sulfation pattern, which indicates that cleavage of the internal β-1,4 linkages is the first step in the degradation of carrageenans.

Desulfation of carrageenans causes them to lose their gelling properties. Asulfatase from P. carrageenovora can remove the sulfate group on κ-carrageenan oligosaccharides. An ι-carrageenan sulfatase removing the sulfate ester at position 4 in ι-carrageenan has only been identified recently from a Pseudomonas sp. This enzyme does not act on the sulfate at position 4 in κ-carrageenan or the sulfate at position 2 in ι-carrageenan, indicating that it specifically recognizes the sulfate on 3,6-anhydro-d-galactopyranoses. The sulfatases are highly specific, as is the case for the carrageenases

Due to the physico-chemical properties of carrageenans, they are often used as stabilizers, gelling agents, emulsifiers, and thickeners in the food and baking industries (ice-cream, cheese, jam, bread dough). Other applications include their use as binders in toothpaste, thickeners and stabilizers in cosmetics, and as smoothers in pet food. Carrageenans have attracted attention in the pharmaceutical industry, since it has been shown, that carrageenan can inhibit attachment of viruses such as the human papillomavirus, dengue virus, and herpes virus. Carrageenans are used in several drug delivery systems as matrixes to control drug release, microcapsules, and microspheres.

### Agars

Agars are industrially produced from the agarophytes red seaweed genera Gelidium, Gracilaria, and Gelidiella. Like carrageenans, agars are hydrophilic galactans consisting of galactopyranose units with alternating α-1,3 and β-1,4 linkages, but, whereas the α-linked galactopyranose is in the d-configuration in carrageenans, agar is made up of 1-galactopyranose units. Some agars contain traces of its precursor porphyran: d-galactose and 1-galactopyranose 6-sulfate. Agar extracted from the red seaweed Laurencia pinnatifida Lamour was identified to contain 2-O-methyl-3,6-anhydrogalactose, 2-O-methyl-1-galactose 6-sulfate, and d-galactose 2-sulfate. The 2-O-methylated anhydro-sugar is the major sugar in agar from Gracilaria eucheumoides Harvey, where it coexists with 6-O-methyl-d-galactose and galactose 4-sulfate. 4-O-methyl-l-galactose occurs as a branch on galactose in the polymer backbone. Methylated agar is found mostly on the commercial agarose which contain some 6-O- and/or 2-O-methylated repeating units.

Agarose refers to the neutral unmodified backbone of agar, of which around 20% of the dimers carry methyl or sulfate groups, while agaropectin is the modified part of agar.

### Physico-Chemical Properties of Agar

The gelling and solubility properties of agar polysaccharides are outstanding among the hydrocolloid polysaccharides because of their relative hydrophobicity: The basic structure is made up of repeating units of alternating 1,3-linked β-d-galactopyranose and 1,4-linked 3,6-anhydro-α-1-galactopyranose that allows agar to form helical dimers according to a mechanism similar to that of the carrageenans. When 3,6-anhydrogalactose is replaced by its biological precursors, 1-galactose 6-sulfate or 1-galactose, helix formation and gel formation is partially prevented because of “kinks”, i.e., the helix has breaking units that lack the 3,6-anhydride bridge.

A comparison of the physico-chemical properties of agar and carrageenan (presumably κ-carrageenan) shows that the gel strength of agar is 2-10 times higher than that of carrageenan, and that the melting point of agar is close to the boiling point of water, whereas the melting point of a carrageenan gel is 50-70° C. The increased gel strength and the higher melting point of agar gels are believed to be associated with the lower content of the anionic sulfates. However, the viscosity of agar in solution at 60° C. is lower than that of carrageenan. The difference is due to the lower molar mass of the agar polysaccharides as compared to carrageenan, for commercial agar preparations, the average molecular weight typically ranges from 36 kDa to 144 kDa; in contrast, the solubility of agar depends on the ability of the solvent to disrupt and melt the ordered conformations, not the molecular weight.

In addition, the high concentration of methoxyl and 3,6-anhydrogalactose moieties in agar increases its hydrophobic properties, allowing agar solubility in hot solutions of 40%-80% aqueous ethanol. The physico-chemical properties make agar gels strong and rigid.

### Extraction and Processing of Agar

The extraction procedure for agar is dependent on the specific seaweed species, but generally involves an alkali treatment followed by hot-water extraction. As with carrageenans, the alkali treatment causes a chemical change in agar (formation of the 3,6-anhydro-galactopyranose) resulting in increased gel strength. The hot-water extraction is done at temperatures around 100° C. for around 2-4 h, sometimes under pressure. The agar dissolves in the water, seaweed residuals are removed by filtration, and the agar is recovered by alcohol precipitation. Agarose is prepared by fractional precipitation methods with e.g., polyethylene glycol 6000, adsorption methods with e.g., aluminum hydroxide, or chromatography methods such as ion-exchange chromatography.

Agar extraction typically requires relatively mild extraction conditions that can promote solubility and gel strength. As with carrageenans, the anhydrogalactose accounts for the gelling capacities of agar. The precursor porphyrin, having 1-galactose 6-sulfate, can be converted into 3,6-anhydrogalactose. The synthesis of 3,6-anhydro-l-galactose has been carried out using a Gal-6-sulfurylase. The reaction leads to the formation of 3,6-anhydrogalactose, by liberating sulfate from the ester linkages of porphyran.

No attempts on enzymatic extraction of agar from red seaweed have been reported, but enzymatic hydrolysis of agars has been demonstrated. This hydrolysis requires agarases, which are classified according to their mode of action: β-agarases that catalyze hydrolysis of the β-1,4 linkages and α-agarases that catalyze hydrolysis of the α-1,3 linkages. The enzyme α-agarase (EC 3.2.1.158) from Thalassomonas sp. can use agarose, agarohexaose and neo-agarohexaose as substrates. The products of agarohexaose hydrolysis are dimers and tetramers, with agarotetraose being the predominant product, whereas hydrolysis of neo-agarohexaose gives rise to two types of trimer. While this enzyme can also hydrolyse the highly sulfated agarose porphyran very efficiently, it cannot hydrolyse the related compounds κ-carrageenan (see EC 3.2.1.83) and ι-carrageenan (see EC 3.2.1.157). The agarose 4-glycanohydrolase (i.e., β-agarase, EC 3.2.1.18) catalyzes the cleavage of the β-(1→4) linkages in agarose in a random manner with retention of the anomeric-bond configuration, producing β-anomers that progressively give rise to α-anomers when mutarotation takes place. The end products of the hydrolysis are neo-agarotetraose and neo-agarohexaose in the case of AgaA (β-agarase genes A), from the marine bacterium Zobellia galactanivorans, and neo-agarotetraose and neo-agarobiose in the case of (AgaB β-agarase gene B).

### Commercial Applications of Agar

Due to its physiochemical properties, agar is used in the food industry as a gelling agent in, e.g., ice-cream and jam, in cosmetics as, e.g., a thickener in creams, and in pharmaceuticals as, e.g., an excipient in pills. In addition, agar is widely used in growth media for culturing bacteria for scientific research. Agarose is also used in biotechnological applications, notably in gel electrophoresis and agarose-based chromatography.

### Alginates

Alginates or alginic acids are distinguished from the other seaweed hydrocolloids because they are extracted from brown seaweeds. In brown seaweeds, alginate constitutes a key component of the seaweed cell walls and also appears to be present in the intercellular space matrix. Alginate therefore appears to be present in most brown seaweed species, but the amounts vary. The main species used for commercial alginate extraction are Laminaria spp., Macrocystis spp., Ascophyllum spp., Sargassum spp., and Fucales spp. —in these species, alginate comprises up to 40% of the dry matter. The relatively low guluronic to mannuronic acid ratio (M:G) of L. japonica yields weakly gelling alginates. Different species of Sargassum and extraction technology employed provide very different yields and quality of alginates. Alginates can also be isolated from bacteria such as Azotobacteria and Pseudomonas, though bacterial alginate production is not employed commercially.

### Chemical Structure and Physico-Chemical Properties of Alginates

Alginates are linear polymers build up by the two monomeric uronic acids, β-d-mannuronic acid (M) and α-1-guluronic acid (G). The two uronic acids are arranged in an irregular blockwise pattern of varying proportions of MM, MG, and GG blocks, depending on algal source, extraction technique, and harvest time. The mannuronic acids form β-1,4 linkages, which gives the MM-blocks a linear and flexible conformation, while guluronic acid gives rise to α-1,4 linkages, and introduces a steric hindrance around the carboxyl groups, thereby providing a folded and rigid structure that ensures the stiffness in the polymer chain

Like the other seaweed-derived hydrocolloids described in this paper, alginate has gel-formation capacities as well. In the presence of divalent cations, mostly Ca2+, the ions can bind to the carboxyl groups in alginate and act as cross-linkers that stabilize the alginate chains by formation of a gel-network. The gelation process predominantly involves cooperative binding of the divalent ions across the GG-blocks of aligned alginate chains, hence the M:G ratio has a major impact on the physico-chemical properties of alginate: Alginates with low M:G ratios (i.e., having relatively high numbers of guluronic acid residues) generally form dense and brittle gels, whereas alginates with high M:G ratios (i.e., with a relatively low number of guluronic acid residues) produce more elastic gels.

The M:G ratio varies amongst brown seaweed taxonomic ranks (i.e., order); typically Ascophyllum nodosum (Fucales) have alginates with an M:G ratio of approximately 1.2; whereas Laminaria japonica (Laminariales) have higher M:G ratios of approximately 2.2, while many Sargassum (Fucales) alginates have M:G ratios ranging from 0.8 to 1.5.

### Extraction and Processing of Alginates

Alginates are extracted in different ways, depending on the application. The alginate is usually extracted as sodium alginate, for example, by converting the insoluble calcium- and magnesium-alginates present within the brown seaweed cell walls to soluble sodium alginates, that are subsequently recovered as alginic acid or calcium alginate. This conversion is done by sequential addition of acid, alcohol, and sodium carbonate.

Enzymatic hydrolysis of alginates has been intensively studied and both β-d-mannuronate and α-1-guluronate lyases that catalyze the degradation of alginate have been isolated from marine algae, marine mollusks, and a wide range of microorganisms.

The two alginate lyases catalyze the degradation of alginate by a β-elimination mechanism targeting the 1,4 glycosidic bond connecting the two uronic acid monomers. A double bond is formed between the carbon atoms at position 4 and 5 in the uronic acid ring, from which the 1,4 glycosidic bond is eliminated, resulting in the production of a 4-deoxy-l-erythro-hex-4-enopyranosyluronic acid. Although the enzymes are classified according to their specificity, they usually have moderate to low processivity for the other epimer.

### Common Applications for Alginates

Alginates are used in the food industry as stabilizers and thickeners in e.g., jelly, drinks, and desserts, and in the healthcare and pharmaceutical industry as wound dressings and matrices to encapsulate and/or release cells

### Enzymatically-Transformed Hydrocolloid-Forming Polysaccharides

In addition to the marine biopolymers discussed above, enzymatically-transformed hydrocolloid forming polysaccharides can be used. Examples include those disclosed in Nishinari, et al., “Hydrocolloid gels of polysaccharides and proteins,” Current Opinion in Colloid & Interface Science, Volume 5, Issues 3-4, July 2000, Pages 195-201.

### II. Formation of Physical Polymer Networks.

The physical networks can be formed by forming a solution of physically-crosslinkable polymers, along with ionically-crosslinkable polymers, and using a change in temperature, pH, or solvent to cause the physically-crosslinkable polymers to physically crosslink.

The polymers described herein can form physical polymer networks via a variety of mechanisms, as described herein. These include complexation in ionic polysaccharides, such as alginates, aggregation of polysaccharide chains into secondary structures through a formation of double helices, formation of physical cross-links by induced crystallization in amorphous regions, and gelation of colloids, such as nanocellulose, by colloidal crowding. Combinations of these approaches can also be used. These various approaches for forming physical networks are described in detail below.

### Hydrogel Formation

A hydrogel is defined as a 3D network formed by hydrophilic polymer chains connected by cross-linking. These chemical properties provide a hydrogel with high water-swelling capacity while being nonwater-soluble. Physically, hydrogels are characterized by a lack of flow under the cuvette inversion test, due to a much larger storage moduli than loss moduli (G′>>G″) and a linear plateau region of the storage modulus, and can hence be classified as a rheological soft solid. These properties are attractive for the biomedical field, as hydrogels can reproduce the hydration conditions of natural mammalian tissues, and mimic some of the physical properties of the extracellular matrix composed of polysaccharides such as hyaluronic acid and protein such as collagen. Within the class of hydrogel-forming polymers, polysaccharides represent a prominent family of macromolecules. One of the main sources for hydrogel-forming polysaccharides is seaweed. As such, algae-extracted polysaccharides have had a tremendous impact on the field of biotechnology. A case in point is the extensive use of agarose hydrogel for DNA sorting and analysis. Without agarose, current advances in molecular biology would not have been possible. Beyond agarose, other polysaccharides extracted from seaweed have been identified, but only a few of them form hydrogels. It can be envisioned that these hydrogel-forming algae-extracted polysaccharides could be a major source of future materials for biomedical applications.

Algae-extracted polysaccharides form hydrogels through physical cross-linking, that is, noncovalent bonding that only relies on weak interactions such as hydrogen bonding, van der Waals forces, and electrostatic interactions leading to a reversible gel formation. Conversely, hydrogels such as poly-(methacrylic acid) form cross-linking points through covalent bonding leading to irreversible gels and are classified as chemically cross-linked hydrogels. While this hydrogel class could be extended to chemically cross-linked hydrogel-forming polysaccharides induced by a cross-linking agent or chemical modification, as demonstrated for laminarin and fucoidan, we chose to focus strictly on polysaccharides that naturally form hydrogels.

The following are hydrogel-forming algae-extracted polysaccharides: alginate, λ-carrageenan, ulvan, starch, agarose, ι-carrageenan, κ-carrageenan, porphyran, and (nano)cellulose.

While polysaccharides extracted from algae are usually classified by the genus of their algae source, this can become challenging, since their properties are strongly dependent on species. Alginate is, for example, extracted from brown algae of the Ochrophyta phylum, encompassing ˜1500 algae species, such as Laminaria hyperborea, Laminaria digitata, and Macrocystis pyrifera with different alginate compositions. Besides the type of species, harvesting season and water quality affect the composition of alginates as well. Since there is a strong correlation between the polysaccharide structure and the properties of the resulting hydrogel, it is crucial to have a deep understanding of the structure-property relationship to gain some predictability to successfully use algae-derived polysaccharides for an industrial biomedical application.

Additionally, the extraction methods and their conditions such as pH, temperature, and mechanical processes, can induce changes in the polysaccharide composition and thus affect the resulting gel properties and commercial potential.

With a focus on industrial-scale biomedical application, we propose a classification of these hydrogel-forming polysaccharides by their mechanisms of physical cross-links. In this respect, it is important to identify the smallest subunit necessary for gelation, as it is the key element in the gelation mechanism, that is, gelator. The gelator will define the gel properties and its processing and, eventually, will determine its final applications.

A deep understanding of the gelator interactions and how chemical modifications will influence them is critical to enable a tuning of the hydrogel properties and a full exploration of the polysaccharide's potential as biomaterials. Within the seven identified hydrogel-forming algal polysaccharides, we identified four classes of gelation mechanisms, driven by either complexation, crystallization, formation of secondary structure, or colloidal assembly (FIG. 13). The chemical structures of polysaccharides described herein, and the classification into these gelation mechanisms are shown, in Table 1.

### Complexation

Some polysaccharides can naturally form complexes with biomolecules such as proteins and lipids. In the case of hydrogel-forming polysaccharides, the gelation can be induced by the formation of a metal complex with the ionic groups of polysaccharides with alginates as the most common example. The gelation occurs because of the formation of a binding between the polysaccharide chain and a coordination center (metals or metalloids). The latter acts as a bridge between individual macromolecular chains and thus forms a cross-linking point. In the formation of the complex, both polysaccharide and coordination center play an equal role, and this formation can be supported by the polyelectrolyte nature of the polysaccharide, through electrostatic interactions leading to further associations.

Alginate is one of the most studied polysaccharides, which gels via an ionic complexation. The polysaccharide structure varies greatly depending on the seaweed growth environment, leading to different polysaccharide compositions. In addition to the culture environment, the polysaccharide composition is dependent on the extracted algae tissue, as it can be extracted from the whole frond or either the algae blade or stipe. Alginate is composed of two saccharide units, β-D-mannuronic acid (M) and α-L-guluronic acid (G) arranged in sequences of M- and G-block regions and randomly inserted M and G units (MGblocks).

It is now well-described that the G blocks determine the stiffness and the M random regions contribute to the flexibility of the resulting polysaccharide. An algae, which is highly exposed to waves, requires a high stiffness to resist the wave's action and will finally produce more guluronate. Hence the season and culture location have a huge influence on the chemical structure of polysaccharides. The difference in polysaccharide composition of the respective algae tissue can be explained similarly; the stipe that mechanically supports the algae requires a higher stiffness than the blade and, hence, is composed of polysaccharides with a higher number of Gblocks. In addition to these factors, the algae species is of course important to consider, as well as the protocol of extraction. A combination of all these factors influences the resulting polysaccharide composition and thereby their gelation and final hydrogel properties.

Once extracted, alginate gels in the presence of divalent cations such as Ca2+, according to the egg-box model. The divalent cations interact majorly with the carboxylate groups of the G-blocks (while the M-blocks have a way lower affinity) through electrostatic interactions leading to a network formation. The gelation was often seen as solely occurring through the G-blocks; however, studies from Donati et al. related the importance of the alternating MG sequences by proving the formation of mixed junctions between G- and MGblocks through nuclear magnetic resonance (NMR). The M/G ratio is defined by the ratio of M to G units. Because of the high affinity of divalent cation toward the G-blocks, the gel properties will greatly depend on the M/G ratio and the G-block length. An alginate with a higher G content and a low M/G ratio will therefore produce a stiffer gel with higher gel strength than an alginate with a high M/G ratio. As the egg-box gelation requires a divalent cation, the specificity of the cation and its concentration will have an impact on the gel properties.

Depending on the cation nature, the minimal concentration required for gel formation, selectivity coefficient, and mechanical properties considerably vary. For instance, it has been shown that Ca2+ exhibits stronger interactions with the alginate than Mg2+, and hence, lower amounts of Ca2+ are required to form strong hydrogels.

λ-Carrageenan is a linear polysaccharide composed of 1,3-linked β-D- and 1,4-linked α-D-galactose substituted with three sulfate groups per disaccharide units, and thus, in the group of selected polysaccharides, it has the highest sulfate content. λ-Carrageenan has a similar gelation mechanism to alginate. However, it is usually only described as a thickening agent unable to form hydrogels. But, a gelation mechanism based on a trivalent cation complexation was reported by Running et al. and Cao et al. The latter confirmed the specific interaction between λ-carrageenan and trivalent cations such as Fe3+ and Al3+, whereas Cr3+ did not cause gelation.

The high sulfate content of λ-carrageenan is of significant importance, as it can lead to antioxidant or anticoagulant properties, a key feature for its consideration in biomedical applications. However, factors such as species, seasons, growth conditions, and extraction processes are known to influence the composition. These factors have been reported to also influence the sulfate content and substitution pattern in ι- and κ-carrageenan and thus may also be of influence in λ-carrageenan. Since these chemical characteristics are key for the biological properties, the development of industrial extraction methods leading to a reproducible chemical structure is critical for their further development into biomaterials.

Ulvan is a sulfated polysaccharide mainly composed of glucuronic acid, iduronic acid, rhamnose, xylose, mannose, glucose, and galactose.64 Several predominant repeating disaccharide patterns have been found, such as a β-D-glucuronic acid 1,4-linked with α-L-rhamnose-3-sulfate and an α-Liduraonic acid 1,4-linked to α-L-rhamnose-3-sulfate. Similar to the other introduced polysaccharides, the structure and composition of ulvan was reported to considerably vary across algae species and seasons of extraction. Ulvan exhibits a particular gelation mechanism, which is reported to occur in the presence of boric acid and divalent cations such as Ca2+ leading to the formation of a thermoreversible gel. It is proposed that the gel occurs either through the divalent Ca2+ ion that acts as a bridge between the borate groups or by the cations that stabilize the coordination of borate with the hydroxyl groups of the polysaccharides.69,70 But, no evidence of borate-polysaccharide complexes could be found by NMR. Further investigation of the gelation mechanism has shown that factors such as the cations and boric acid concentration were influencing the gel properties. The metals involved in the complexation of alginate and λ-carrageenan interact differently with the ulvan polysaccharides.

In ulvan gels, it was found that Cu2+ cations led to the formation of a stronger hydrogel than with Ca2+, whereas no gel formation was observed in the presence of Mg2+. Shedding light on the hydrogel formation mechanism of ulvan could be very beneficial and lead to interesting applications, for example, in metal coordination for the removal of metal.

### Crystallization

With respect to synthetic polymers, crystallization is a well-known process that impacts the material properties, and similar observations have been made in natural polysaccharides as well. The process of crystallization can be controlled by an application of cooling rates or anisotropic stretching of the polymer chains. In the course of crystallization, a network can form through the interconnection of crystalline regions (crystallites, spherulites) acting as junction zones between the amorphous regions. In synthetic polymers like polypropylene, the process is often known as a two-step mechanism involving the nucleation of crystals followed by their growth. However, more complex mechanisms involving spinodal decomposition or the appearance of a mesomorphic phase have been observed in natural polysaccharides.

Starch is a polysaccharide composed of two polysaccharides, namely, amylose and amylopectin, and is primarily extracted from plants such as potato, maize, and wheat, but it also occurs in algae. Starch amylose is a linear gel-forming polysaccharide mostly composed of 1,4-linked α-D-glucose with small numbers of 1,6-linked α-D-glucose unit branches, while amylopectin is a highly branched polysaccharide composed of 1,4-linked α-Dglucose heavily interlinked with 1,6-linked units. The starch composition and ratio of amylose and amylopectin vary depending on the species and whether it is from land plants or algae, and this ratio influences the starch gelation. For instance, starch extracted from the red seaweed (Rhodophyta) called Floridean starch lacks amylose and thus does not gel. Starch gelation is attributed to a crystallization process and occurs through gelatinization and retrogradation, which is an order-disorder transition induced by a heating and cooling cycle. Amylose forms a gel through a phase separation followed by crystallization occurring in the polymer-rich phase.

Amylopectin contributes to the network formation through a slow retrogradation mechanism (days) that increases further the crystallinity and long-term stability. Because of this mechanism, the amount of amylopectin and the amylose/amylopectin ratio play an important part in the gelation.

Retrogradation is a complex process that depends on many factors such as the chain length of amylopectin and the starch phosphate content. As the cross-linking points are established through the crystalline regions, the concentration of the polysaccharide and the crystallization conditions such as the temperature and the cooling rate will have an impact on the crystallite morphology and thus the gel properties.

For instance, an increase in the cooling rate has been reported to yield a softer gel, as it gives the macromolecular chains a smaller time frame to reorganize and form ordered regions.

### Formation of Secondary Structures

The secondary structure of a polymer is the 3D structure adopted by the macromolecular chains. In solution, some polysaccharides can go through a coil-to-helix transition. Like DNA polymers, polysaccharides such as agarose and κ-carrageenan form double helices in solution. Once formed the helix can aggregate to create cross-linking points between the polymer chains leading to the formation of a 3D network. The aggregation of helices is driven (especially in the case of agarose93 or κ-carrageenan) by electrostatic interpolymer chain repulsions and stabilized by weak attractive interactions. In these polysaccharide systems, the helices can be interrupted due to kinks that are induced by the irregularity in the polymer chains, which thus controls the size of the cross-linking points.

Agarose is one of the polysaccharides constituting agar, the other one being agaropectin, which has the same backbone as agarose but with sulfated galactose and pyruvic acid residues. The purification and extraction process of agarose is therefore an important step, as agaropectin is a nongelling polysaccharide.

Agarose's backbone is composed of β-D-galactose and 3,6-anhydro-α-L-galactose (3,6-AG) similar to the one from ι- and κ-carrageenan. Changes in the composition and structure of agarose polysaccharide such as the presence of α-L-galactose and other minor substituents (sulfate, methyl ether, pyruvic acid) are known to occur depending on the species and seasons.

The composition of agarose controls the formation of secondary structures of the polysaccharide governing its gelation mechanism. It is believed that agarose gelation occurs through a phase separation mechanism, involving the formation of double helixes in the polymer backbone and aggregations of these helices into cross-linking points creating a 3D hydrogel network. However, the phase separation mechanism is still debated, and both spinodal decomposition100,101 and nucleation/growth are reported in the literature. The gelling properties are correlated with the structure of agarose, in which the equatorial hydrogens of the 3,6-AG residues force the chains into a helix. Replacing the 3,6-AG by a 6-O-sulfo-Lgalactose interrupts the helix by a kink formation leading to a lower gel strength. This principle can be used to tune the mechanical properties of the hydrogel through a chemical modification. Additionally, to modulate further the gel properties, the polysaccharide concentration can be increased to induce a stronger helix aggregation resulting in a stronger gel strength.

ι- and κ-Carrageenan gelation occurs through the addition of monovalent or divalent cations to inhibit the electrostatic repulsion between the hydrogel chain due to the presence of charged groups. While ι- and κ-carrageenan have the same backbone, composed of β-D-galactose and 3,6-AG, they differ in sulfate content; ι-carrageenan possesses sulfate groups on both galactose and 3,6-AG, while κ-carrageenan features only substitution on galactose units. This difference affects the respective gelation mechanisms leading to different mechanical properties of the hydrogels, κ gels being strong and brittle while ι gels are softer.

Like other algae-extracted polysaccharides, many factors such as species, seasons, growth conditions, and extraction conditions are influencing the 3,6-AG and sulfate content, which in turn alters the helix formation leading to different gel properties.

In the presence of cations, ι- and κ-carrageenan go through a coil-to-helix transition, leading to the formation of double helices. In κ-carrageenan the helix formation is followed by further helix aggregation, but this aggregation does not occur in ι-carrageenan due to the presence of two sulfate groups inducing a stronger electrostatic chain repulsion.

In the case of κ-carrageenan, the gelation is dependent on monovalent cations. The type of cation used to induce the gel formation will impact the mechanical properties of the hydrogel. For instance, κ-carrageenan forms a stronger gel with K+ than with Na+. Not only cations but also some anions such as I- and SCN- have been reported to bind to the helix influencing the gelation mechanism by impeding helix aggregations and gelation. Since the ι- and κ-carrageenan hydrogel formation is governed by their secondary structure, manipulation of this structure, for example, through the addition of ions, can have a drastic impact.

Porphyran is a sulfated polysaccharide composed of alternating 6-O-methyl-β-D-galactose, 6-O-sulfo-α-Lgalactose, and 3,6-AG units. Differences in the composition occur depending on the species. However, it was reported that, in nature, the sum of the β-D-galactose and 6-O-methyl-β-Dgalactose is equal to the sum of the 6-O-sulfo-α-L-galactose and 3,6-AG units. Porphyran can only form hydrogels after an alkaline treatment that removes the sulfate groups on the polysaccharide backbone. While the modification of the backbone is necessary, the gelation is a physical process, and it does not need any additional reactive species, such as methacrylate groups used in synthetic and chemical hydrogels. This alkaline treatment is also often used during processing of agarose and carrageenan, converting the 6-O-sulfo-L-galactose into 3,6-AG. Thereby, the mechanical properties of the hydrogel are generally improved by “dekinking” the backbone and thus allowing longer helical structures to form.

Once the sulfate groups are removed, porphyran gelation occurs through the aggregation of double helices. Only a few studies have been published on porphyran, and therefore further work is required to better understand its gelation mechanism and the factors influencing its hydrogel properties. This will be helpful to fully exploit its physical and biological properties for applications in biomaterials.

### Colloidal Assembly

Within the family of hydrogel-forming polysaccharides extracted from algae presented and discussed herein, nanocellulose is the only polysaccharide having a colloidal-based gelation mechanism. Cellulose is composed of β-D-glucose units and can be obtained from various sources including plants, algae, and bacteria. Bacterial cellulose is a native strong, irreversibly entangled hydrogel, while algae and plant cellulose needs to be processed into nanocelluloses to form a hydrogel. Nanocelluloses are colloids, solid nanoparticles homogeneously dispersed in aqueous media. They are obtained through a deconstruction of the cellulose fiber into individual nanosized building blocks, which can be dependent on the treatment, either cellulose nanofibers (CNF) or nanocrystals (CNC).

These colloids feature a fluid-like character in a diluted state and have a gel-like behavior at higher concentrations. The transition from the diluted state into a gel is reversible and based on repulsive particle-particle interactions. Hydrogels are formed upon a concentration threshold of the colloid, that is, critical concentration, which is mainly dependent on the aspect ratio and volume fraction of the colloid. In the case of CNF, the individual nanofibers form entanglements, and thus their aspect ratio and flexibility can favor the hydrogel formation. The colloidal characteristic of the hydrogel formed by nanocellulose confers their shear thinning properties. Such flow properties make nanocelluloses easily processable as a gelled material and allows the embedment of living cells for injection into animals.

This shear-thinning property is also an attractive attribute as rheology modifier in 3D printing inks. However, in contrast to other polysaccharide gels, such as agarose, native nanocellulose in the hydrogel state lacks a physical stability and is dispersed upon dilution. Thus, to overcome this limitation, nanocellulose is often combined with other hydrogel-forming polysaccharides extracted from algae.

### III. Formation of Physical and Ionic Crosslinks Between Marine Polymers to Form a Dual Interpenetrating Network

Marine biopolymers can be processed into materials that possess both elastic and plastic behavior within a single system, involving a double interpenetrating polymer network comprising an elastic phase of dynamic physical crosslinks and stress dissipating ionically-crosslinked domains. In some embodiments, films formed from these double interpenetrating polymer networks can have over 2-fold higher elastic modulus, ultimate tensile strength and yield stress relative to polylactic acid

Physically-crosslinked networks can be prepared by blending two or more water-soluble marine polysaccharides, for example, one or more ionically-crosslinkable polymers, such as alginic acid (Alg), and one or more physically crosslinkable polymers, such as carboxylated agarose (CA). The physically-crosslinkable polymer(s) can be induced to physically-crosslink, for example, by changing the temperature, pH, or solvent (i.e., by adding a non-solvent for one or more of the polymers). This entraps the ionically-crosslinkable polymers in the physically-crosslinked polymer network. Then, the ionically-crosslinkable polymer(s) can be ionically crosslinked, for example, using divalent cations, such as calcium ions, polyvalent ions, or diamines/polyamines. Although in this example, the network comprises these specific marine polymers and calcium as the ionic crosslinking agent, the process can be applied to any combination of marine polymers, and any ionic crosslinking agent.

The solvent, such as water, which may also comprise a water-miscible organic solvent such as an alcohol can then be removed, for example, by distillation, or in a drying oven, such as a vacuum oven.

Films formed using this process, in this example, dried CAAlg films, tend to show homogeneous nano-micro scale domains. The yield stress and size of the domains tends to scale inversely with the concentration of the ionic crosslinking agent, for example, the calcium ion concentration.

Through surface activation/crosslinking using these films, for example, calcium CAAlg films, the films can be further processed using wet-bonding to yield laminated structures. These laminated structures can have interfacial failure loads (13.2±0.81 N) similar to the ultimate loads of un-laminated films (10.09±1.47 N).

By way of example, the films can be used to prepare wood-marine biopolymer composites, where a solution of the physically crosslinked polymers can be applied, for example, by printing methods, including three dimensional printing, spraying, doctor blading, dip coating, and the like, onto wood veneers (panels), ideally in a suitable pattern or array. The solvent can then be dried, and the polymers ionically crosslinked with an appropriate metal ion or cationic polymer, then bonded to yield fully bonded wood 2-ply laminates. As such, the system presented herein provides a blueprint for the adoption of marine algae-derived polysaccharides in the development of sustainable high-performance materials.

Other composite/laminate materials can be prepared in a similar manner, where wood is replaced with another material, such as carbon fiber, clay, steel, aluminum, copper (or metal in general), plastic, tiles (clay or brick), paper, cotton, or other cellulosic materials.

### IV. Formation of Covalent Linkages

In some embodiments, one or more of the polymers in the dual interpenetrating networks further comprises covalently crosslinkable groups. For example, free radical polymerization can be used to covalently cross-link the polymer networks, where the polymers include olefinic groups, which can be cross-linked with di, tri-, and oligomeric olefin-containing groups, such as (meth)acrylates, vinyl esters, vinyl ethers, vinyl sulfones, vinyl sulfonates, thiol-enes, and the like. The free-radical polymerization can be performed using light-curing techniques, and/or using chemical free radical initiators such as t-butyl peroxide, AIBN, and/or gamma radiation, light, heat and the like.

Natural products, which include one or more covalently crosslinkable groups, can also be used. Examples include lignins, polyphenols, catechols, green tea extract, and tannic acid.

Covalent crosslinks can also be formed, for example, using condensation polymerization. In this example, at least one of the marine polymers comprises functional groups that can be used in condensation polymerization reactions, for example, amine-aldehyde (imine bond formation), reaction of epoxy with amine, and the like. In some aspects of this embodiment, the amine is introduced as part of the physical network or as part another difunctional polymer/oligomer, and the epoxide can be introduced as a diepoxy or other polyepoxy moiety. Also, polyols and polyphenols can be used to effect covalent crosslinking. By way of example, ester linkages can be formed with carboxylic acid groups on the polymer networks, where the carboxylic acid groups are not ionically crosslinked with a metal ion or cationic polymer. Similar chemistry can be used to form linkages with sulfinic acids, phosphinic acids, and the like.

### IV. Optional Additional Agents

In some embodiments, the double interpenetrating polymer networks are used to deliver one or more biological agents, such as antimicrobial compounds, anticancer compounds, anti-inflammatory compounds, and the like.

The polymer networks can also be “filled,” and representative fillers include antimicrobial agents, such as ionic liquids, copper and silver colloids and salts, antimicrobial peptides, quaternary ammonium salts, and cationic polymers, so long as the cationic polymers do not affect the ionic crosslinking.

Additional fillers include clay, laponite, silicates, talc, graphene, carbon colloid, C60, nanotubes (carbon and metals), metal “whiskers,” including nano-whiskers, glass fibers, wood powder, saw dust, silica colloids, nanocellulose, nanocrystalline cellulose, cellulose nanocrystals and the like.

### V. Processes for Forming Articles of Manufacture Using the Double Interpenetrating Networks

The double interpenetrating networks can be processed into articles of manufacture, including coatings and films, as well as articles prepared by casting, molding, and the like. When preparing films, a variety of methods can be used. For example, a solution of the networks can be prepared, and solution casting methods can be used to form a film, and/or to apply a film to a substrate, such as a wooden, metal, ceramic, clay, plastic or other suitable substrate. When solution casting is used, any suitable method of applying the solution to the substrate can be used, for example, doctor blade, roll casting, spin casting, spray coating, and the like. In some embodiments, after the physically networked polymers are applied to the substrate, the polymers can then be ionically crosslinked, and the solvent removed, to form a film.

In some embodiments, a three dimensional printer can be used to apply a solution of the polymer to a component for which a laminate is to be formed. The printer can be used to apply a pattern or array of the physically linked polymer solution to the substrate, and the polymers can then be ionically crosslinked.

Representative surfaces that can be coated include wood, clay, glass, porous synthetic materials, earthen tiles, clay articles, ceramic articles, and pottery

When used in injection molding applications, the polymer network can be formed by completing the physical and ionic crosslinking steps, and solvent can be removed. The polymer can then be extruded, molded or cast, into a desired shape.

The present invention will be better understood with reference to the following non-limiting examples.

### Example 1: Preparation of Double Interpenetrating Polymer Networks

### Abstract

A sustainable circular economy requires materials that possess a property profile comparable to synthetic polymers and, additionally, processing and sourcing of raw materials that have small environmental footprint. Here, we present a paradigm for processing marine biopolymers into materials that possess both elastic and plastic behavior within a single system involving a double interpenetrating polymer network comprising of elastic phase of dynamic physical crosslinks and stress dissipating ionically crosslinked domains. As a proof of principle, films possessing over 2-fold higher elastic modulus, ultimate tensile strength and yield stress than polylactic acid were realized by blending two water-soluble marine polysaccharides, namely, alginic acid (Alg) with physically crosslinkable carboxylated agarose (CA) followed by ionic crosslinking with a divalent cation. Dried CAAlg films showed homogeneous nano-micro scale domains, with yield stress and size of the domains scaling inversely with calcium concentration. Through surface activation/crosslinking using calcium CAAlg films could be further processed using wet-bonding to yield laminated structures with interfacial failure loads (13.2±0.81 N) similar to the ultimate loads of unlaminated films (10.09±1.47 N). Towards the engineering of wood-marine biopolymer composites, array of lines of CAAlg were printed on wood veneers (panels), dried and then bonded following activation with calcium to yield fully bonded wood 2-ply laminate. The system presented herein provides a blueprint for the adoption of marine algae-derived polysaccharides in the development of sustainable high-performance materials.

### Introduction

The challenges of implementing a circular economy lie in not only finding solutions that exhibit a low carbon footprint, but also developing materials that can emulate the property profile of existing petrochemical based synthetic polymers. In the past few years, significant advances have been made to implement sustainable circular economies including implementing life cycle thinking (LCT) in product development (1-3) and new approaches to processing synthetic polymers to extend their life cycle such as, introduction of additives to reduce degradation, repurposing, self-healing, and upcycling of bio-based fillers (4-6). However, these strategies do not address the main environmental impact of petrochemical-based materials, which is their inability to undergo degradation in landfills. Natural sources could potentially serve as an alternative to petrochemical sources for high performance materials if the performance gap is addressed (7, 8). In this regard, there have been significant efforts in combining plant-based materials like cellulose, lignins, and their derivatives with existing petrochemical-based material to develop a class of hybrid materials (9-11), and this class of materials has been gradually replacing traditional synthetic polymers in packaging, disposable tableware, and utensils (12-15). However, as a recent study has highlighted, the environmental impact of sourcing biopolymers, such as polylactic acid (PLA) cannot be ignored (16). For example, the lactic acid for Luminy® PLA produced by Total Carbion is sourced from sugarcane. Sugarcane farming is very damaging to the soil and after two seasons of cultivation makes the soil unsuitable for further farming.

Furthermore, the water irrigation and manpower requirements to sustain sugarcane farms are energy and human resource intensive. Nonetheless, materials incorporating biopolymers offer a bridge between the purely synthetic materials and the natural materials. An alternative source of raw material, that might address more comprehensively a sustainable circular economy is marine derived polysaccharides. Since algae-derived polysaccharides are the product of carbon dioxide consumption by the algae, i.e., they act as CO₂-sink, and can be grown in biomass cultures in large quantities; they also offer a favorable environmental footprint (17). Furthermore, several marine polysaccharides (chitosan, carrageenans) and hydrocolloids such as agar and agarose show excellent film forming properties and are used in food packaging. However, the main drawback lays usually on the poor mechanical, thermal, and water vapor barrier properties because of their hydrophilic structure (18-21). Addressing this limitation could potentially make them attractive for mainstream applications such as laminates for flooring and wall paneling, and applications where impact resistance is essential.

The time and tested approach to improve mechanical properties in synthetic polymers is the introduction of permanent crosslinks between polymer chains using epoxy or acrylate chemistry.

Chemical crosslinking, while offering several advantages, presents issues with respect to reversibility, processing, and toxicity. In contrast, physical crosslinks which in synthetic polymers are only accessible in simple highly ordered backbones such as polyethylene and polypropylene, are the basis for association of polymer chains in several biopolymers such as agarose and carrageenans, and this can offer clear advantages in reproducibility and scaling as they are driven by specific affinity between secondary structure of macromolecules and are therefore thermodynamically favored and reversible and can be realized in solution. For instance, exoskeleton of marine arthropods and cephalopods which are also composed of biopolymers possess exceptional properties (toughness, processing) and have been the subject of extensive investigation (22). The organization of biopolymers in these systems provides a compelling blueprint for the design of new functional materials, based on biopolymers (23, 24). For example, in the dactyl club of the mantis shrimp, the presence of nanocrystals of fluoride apatite in the chitosan organic matrix has been shown to be essential for its exceptional toughness as these crystals play a critical role in preventing stress propagation (25, 26). Interpenetrating networks (IPNs), which are systems composed of two-entangled (or interlaced) polymer networks (27) have been extensively explored in engineering hydrogels. An emerging concept in design of materials that can absorb an enormous amount of stress (super elastic and super tough) without undergoing failure is double (dual)-IPNs (d-IPN). D-IPNs (also referred to as double network (DN)) are very attractive as a paradigm for engineering materials as the presence of two (typically independently crosslinked) co-continuous networks of different physicochemical properties allow for stress propagation through distinct mechanisms that are inherent to each network and therefore independent of each other. Such DNs are typically realized by a two-step synthesis, where the first crosslinked network is used as the matrix for the formation of the second crosslinked network. Extending on this, it has been demonstrated that crosslinked polyacrylamide impregnated within a network of the brown seaweed-derived polysaccharide-alginate (Alg, alginic acid sodium salt) ionically crosslinked with calcium ([Ca2+]), that is, a DN of one permanently crosslinked network and a second deformable/reformable network, can undergo large deformation (1000%) under cyclic load without imminent failure (28). Both IPNs and d-IPNs (DNs) have been exploited in recent years to impart bulk properties such conductivity and charge storage capacity in biopolymers (29, 30), and to engineer biopolymer hydrogels for example, ionic-covalent entanglement hydrogels contained nesosilicate fillers (31), covalently crosslinked hyaluronic acid (HA) hydrogels containing dynamic non-covalent crosslinks in the form of cyclodextrin-adamantane host-guest interactions(32), and HA-Elastin crosslinked hydrogels with dynamic covalent hydrazone linkages and temperature induced elastin physical crosslinks (33).

Inspired by stress dissipation mechanisms in metals, where dislocation of atoms within grains dissipates stress and grain boundaries function as stress arrestors, we envisioned that a d-IPN comprising of one network with dynamic elastic net points and the other possessing stress dissipation properties, could yield materials that can exhibit both elastic and plastic behavior. Based on this paradigm, we report herein the fabrication of carboxylated agarose (CA)/Alg blend composite (CAAlg) films that possess tensile modulus (E, Young's modulus) and Ultimate tensile strength at yield that exceed that of PLA films; and are further amenable to processing into laminated structures through interfacial ionic bonding. The realization of superior mechanical properties in marine polysaccharide-based materials can pave the way for exploration of these biopolymers in fabrication of structural composites and engineered products based on natural materials.

### Results and Discussion

### System Design

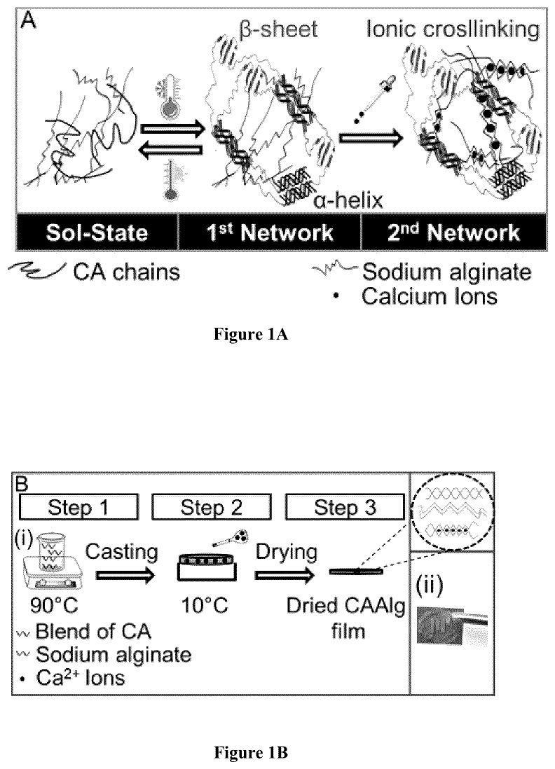

We conceptualized a d-IPN comprising of one network undergoing dynamic physical crosslinking through a combination of weak and strong H-bonding, and another undergoing ionic crosslinking. In such a framework, the introduction of multivalent metal ions would in theory promote the formation of densely crosslinked structures driven by the nucleation and growth of ionic net points and a system with dedicated stress dissipation domains. To test this hypothesis, we exploited two water-soluble marine algae derived polysaccharides, namely, CAs, derivatives of agarose that exhibit tunable sol-gel transition around room temperature and thus remain a liquid during processing, and undergo physical crosslinking through a combination of weak β-sheet-β-sheet/β-strand-β-strand interactions and strong helical-helical interactions (34), and sodium-Alg, that can be post-processed into crosslinked domains using calcium (FIG. 1A). Unlike in the study by Sun et al., (28) where Alg was purely used as one of the bi-continuous networks, we aimed to use Alg not only as a stress dissipation component but also as a component that forms discrete nanoscale domains that can act as strain hardening elements.

Carboxylated agarose-alginate blends (CAAlg) can be processed into homogenous nanostructured films Physically crosslinked system offers two clear advantages: (i) it can be reversibly formed and reformed using temperature, thereby allowing temperature-based processing of the material, and (ii) will lead to homogeneous crosslinking since the molecular self-assembly process in aqueous environment is thermodynamically driven. Besides the obvious environmental upsides to water-based processing, unlike casting films from organic phases where solvent evaporation can severely impact film properties by inducing phase separation (35), here, during the sol-gel transition, the increasing viscosity ensures that the macromolecules possess near-zero diffusion coefficient thus avoiding phase separation and should lead to reproducible film formation with enhanced homogeneity.

We first tested the film forming properties of CA of various storage modulus (G′) and identified that a 5 w/v percent 1:1 blend of the medium CA (G′, 2270±864 Pa) and the soft CA (G′, 16±0.62 Pa) yielded reproducible films after gelation at 10° C. While cross-linked calcium alginate yields brittle films that undergo shrinkage (FIG. S1), introduction of sodium alginate in the CA system at a ratio of 25% by weight of the total polysaccharide content, did not disrupt physical gelation of the CA and had no noticeable impact on the film forming properties of the CA blends.

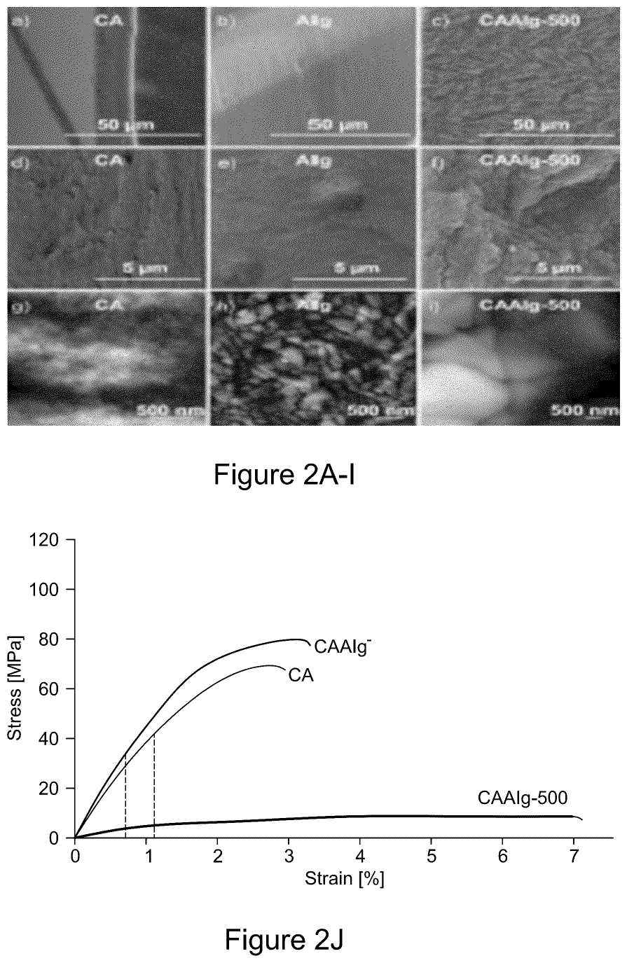

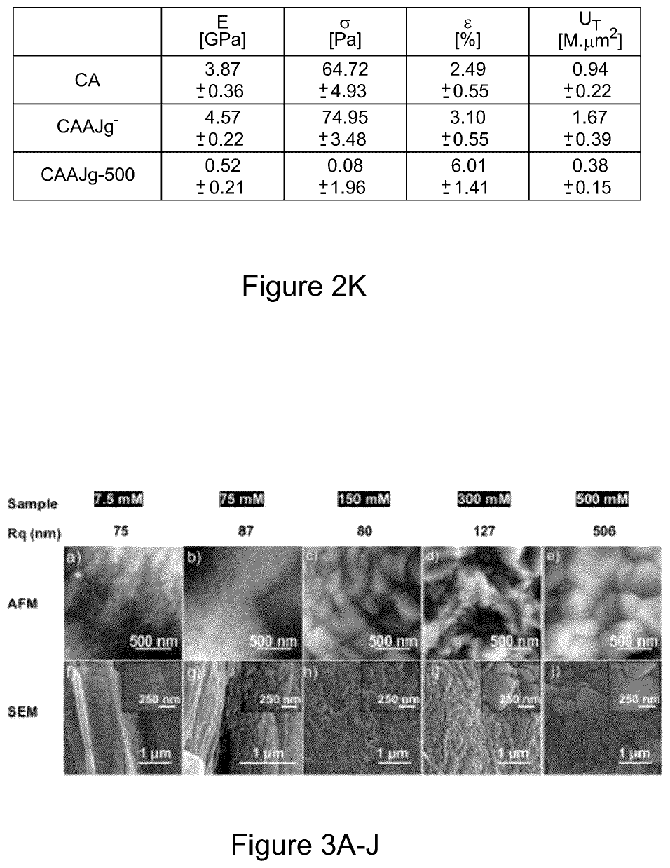

Based on these observations a process involving hydrogel casting followed by calcium crosslinking was implemented (FIG. 1b, Steps 1-2). Based on a recent paper describing the preparation of alginate films (36), we first explored a [Ca2+] of 500 mM. The CAAlg films were exposed to calcium for 15 mins and then desiccated for 72 hours, and for comparison a 5% alginate film was crosslinked under identical conditions (FIG. 1b, step 3). The dried state of the film was confirmed by TGA analysis which revealed a ˜9% w/w of water in the films (FIG. S2). Scanning electron microscopy (SEM) of dried CA-blend films as expected, revealed an amorphous microstructure (FIGS. 2a and 2d) and tapping mode AFM images revealed the presence of a fibrous network akin to what has been previously reported for pure CA films (FIG. 2g) (37). In the case of calcium-alginate films although no specific morphology was observed in the SEM images (FIGS. 2b and 2e), AFM images revealed a closely packed structure comprising of irregular shaped nodules less than 100 nm in average diameter (FIG. 2h). However, CAAlg films revealed a distinct morphology that can be attributed neither to the CA nor the Ag component (FIGS. 2c, 2f and 2i). It is plausible that these structures are the result of the aggregation of multimers produced by the lateral association of egg-box dimers formed upon calcium-induced crosslinking of guluronic acid in the alginate chains (38). In the case of the calcium free CAAlg films (CAAlg*), neither phase separation between CA and calcium alginate nor any distinct morphology was observed (FIGS. S3a and S3b). This observation was a bit surprising as the calcium alginate content is only 25% of the total polymer mass, nonetheless, this led us to conclude that the addition of calcium promotes the association and aggregation of alginate chains, resulting in the evolution a nano-scale phase.

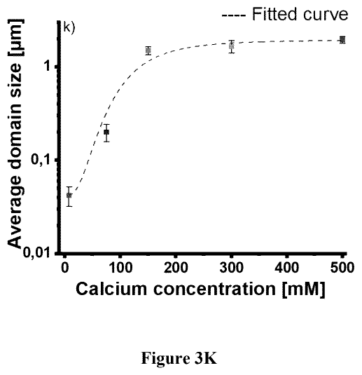

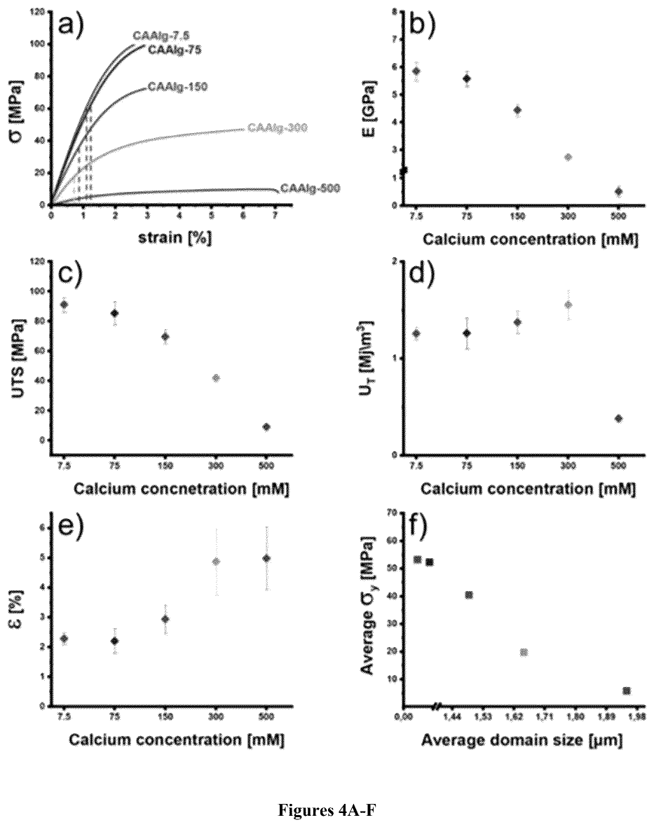

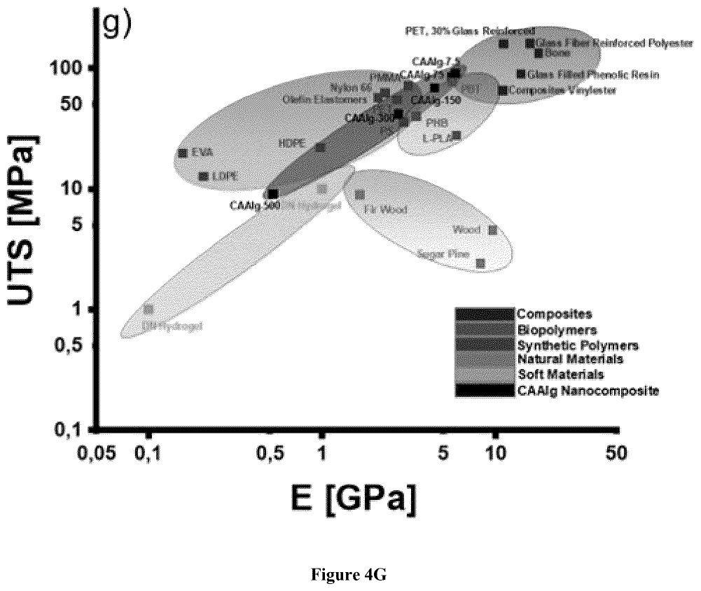

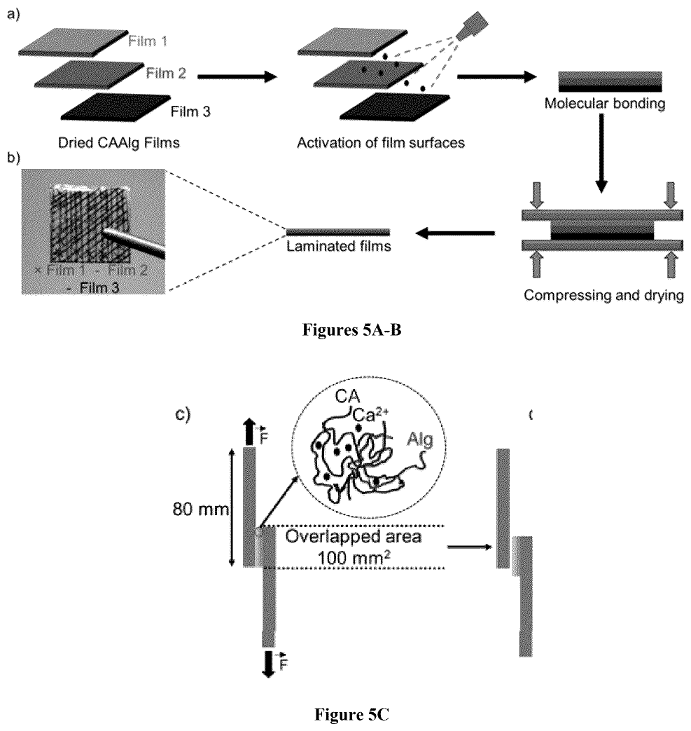

To ascertain if the nano structures are an artifact of drying process, wet films were observed using environmental scanning microscope. Imaging at increasing chamber pressures revealed the preservation of nano-scale domains confirming that this was an inherent property of CAAlg films (FIG. S4). Furthermore, since CA bears carboxylic acid groups that can also chelate with divalent cations, we investigated the rheological behavior of CA gels (1 w/v %) at 0.1 and 1 Hz in presence and absence of calcium and observed no appreciable differences in G′ in all conditions, thus excluding any major contribution of CA chains in the formation of the ionic network (FIG. S5). Representative stress strain curves of air dried 5% CA, and 500 mM CAAlg air dried films before and after crosslinking with calcium and key film properties (Elastic modulus (E), Ultimate tensile strength (UTS), elongation at break (ε), toughness (UT), and yield stress (σy)) are shown in FIG. 2j and FIG. 2k, respectively. As postulated the introduction of dynamic ionic crosslinks introduced plastic behavior in the films due to the ability of ionic crosslinks to absorb and dissipate energy, resulting in films that underwent on an average 2.5-fold (6.01±1.41%) greater elongation than CAAlg* and CA films. However, this increase in plastic behavior comes at the expense of stiffness and toughness in the films. Since, the mechanical properties are postulated to evolve due to a balance between physical and ionic crosslinks, reducing plastic deformation should in theory increase stiffness and toughness of the films. To test this premise the effect of lower [Ca2+] on CAAlg films was investigated as elucidated below. [Ca2+] modulates size of nano structures and mechanical properties of CAAlg films CAAlg films were crosslinked using a range of [Ca2+] spanning over two decades from 300 mM to 7.5 mM. While lowering the [Ca2+] by 1.5-fold from 500 mM to 300 mM yielded a clear but modest reduction in the average size of the nano-structures from 2 μm to 1.7 μm, further decrease to 150, 75 and 7.5 mM resulted in a logistic regression in average domain size up to 4.3 nm (FIGS. 3a-e, and 3k). SEM analysis revealed that the decrease in domain size occurred uniformly across the entire film (FIG. 3f-j). Importantly, CAAlg films exposed to lower [Ca2+] showed progressively superior properties in comparison to films crosslinked at 500 mM. A linear relationship between E values and decreasing [Ca2+] was observed with mechanical properties peaking at and beyond 75 mM [Ca2+](FIG. 4a). Crosslinking at 300 mM resulted in a nearly 5-fold increase in average E values (0.52 to 2.5 GPa) with further gains in stiffness going from a [Ca2+] of 150 mM to 75 mM with highest average E values of 6.3 GPa attainable at [Ca2+] of 7.5 mM (FIG. 4b). This represented a nearly 11-fold increase in stiffness in comparison to the 500 mM case, and additionally, up to 10-fold higher values in ultimate tensile strength (UTS) (10 to 100 MPa) (FIG. 4a, c). Furthermore, all CAAlg films crosslinked at lower [Ca2+] exhibited distinct elastic and plastic regimes (dashed lines in FIG. 4a) with such distinct transition from elastic to plastic behavior being absent in the films produced in the 500 mM condition. The direct consequence of the evolution of a plastic regime in CAAlg films was a 3-fold increase in toughness (UT, 0.38 to 1.26 MJ/m3) (FIG. 4d). Once could postulate reducing the size of nano-scale domains limits stress propagation while preserving stress dissipation thus giving rise to films that are stiff plastics. These results in sum provides compelling evidence that the divalent calcium is responsible for driving the formation of the nano-scale domains in CAAlg composite films which is central to the structure-property relationships in the CAAlg films.

A highly consequential finding was that CAAlg films crosslinked at [Ca2+] of 75 mM and below possessed E, UTS, UT that exceeded that of semi-crystalline biodegradable; polymer PLA (E: 2.3-3 GPa; UTS: at 36 MPa (39, 40)) with E values greater than 2× that of PLA and nearly 4-fold higher UT values compared to CAAlg-500 films. Furthermore, CAAlg films also show significantly superior mechanical property profile in comparison to LDPE (UTS 6-28 MPa and E is 0.14-0.48 GPa) (41, 42). These findings are counterintuitive as the alginate phase being physiochemically distinct from CA should demix from CA phase during the film formation and promote brittle structures. The enhancement of mechanical properties in CAAlg films can be rationalized as follows. The correlation between Ca-crosslinked Alg-rich domains and UTS (FIG. 4c) suggests that these micron-nanoscale domains play an important role in the improvement of mechanical properties. This reasoning is further substantiated by AFM images of films after tensile deformation which showed elongation of domains and also an overall increase in domain size in CAAlg-500 presumably due to coalescence and growth of domains during deformation, a phenomenon routinely also observed in metal alloys during superplastic deformation (43) (FIG. S6). Furthermore, the decrease in fracture strain in CAAlg films with decreasing [Ca2+](FIG. 4e) can be attributed to molecular failure within the ionic crosslinked domains, and furthermore, the almost 2-fold increase in fracture strain going to 75 mM to 500 mM [Ca2+] is consistent with the expected increase in crosslink points with increasing [Ca2+](FIG. 4e). In sum, the crosslinked calcium alginate-rich phase as hypothesized, therefore, functions as a stress dissipator as it also introduces plastic behavior in these composite films in comparison to pure CA and CAAlg* films (FIG. 2j). At high [Ca2+] of 300 and 500 mM, plastic behavior becomes dominant with films exhibiting elongation of 6-7%, although accompanied by lowering of the UTS presumably due to perturbation of elastic net points of the CA as the ionic crosslinked domains start to dominate the film structure. Interestingly, in films crosslinked with [Ca2+] of 300 mM it was possible to combine toughness and plastic behavior in the same system which is reminiscent of stress-strain behavior observed in semi-crystalline synthetic polymers such as LDPE for example and paves the way for replacing synthetic polymer-based films with CAAlg films in selected applications. This is also a consequential finding as it demonstrates that the d-IPN paradigm presented herein is capable of modulating material properties through simple variation of a single parameter namely, [Ca2+].

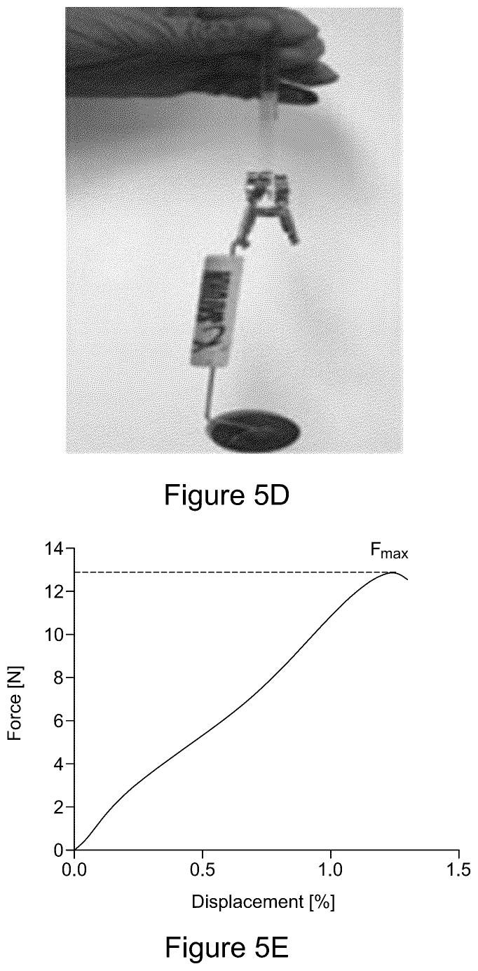

The evidence for a clear role for alginate in the evolution of the mechanical properties can be inferred by the extreme case, i.e., the films crossed a [Ca2+] of 500 mM. Under these conditions, a dramatic increase in domain size, exceeding 1 micron, is observed and this is accompanied by an order of magnitude loss in TS and toughness and ay (FIG. 4f). This leads us to conclude that the domains in CAAlg films essentially function as grain boundaries in metals as they can mitigate fracture by absorb stress through breakage and reformation of the ionic crosslinks without loss to domain integrity. To place the mechanical properties of CAAlg films in perspective, an Ashby plot of UTS versus E was generated and it is evident that the property profile of CAAlg films is comparable to many synthetic petroleum-based polymers, comparable to or exceeds the properties of degradable polymers, and can approach the lower spectrum of properties observed in glass fiber filled composites. Interestingly, CAAlg films show superior properties when compared many of the common soft woods (FIG. 4g). This bodes well for the exploration of CAAlg films in fabrication of structured and engineered materials. CAAlg films can be processed into laminated structures through wet-bonding Biopolymer derived composites are typically plagued by scale-up and processing issues. Towards realizing sheets and panels composed of CAAlg composite, we conceived as process for laminating CAAlg films at ambient conditions that involves activation of the film surface using calcium to promote polymer chain entanglement in a pressure-induced bonding scenario (FIG. 5a).

As proof of concept, a laminated object was prepared from three films using this semi-wet laminating process (FIG. 5b). First the film surfaces were activated using a 150 mM CaCl₂) solution then bonded under compression together for 48 h. The formation of bonded interface and the dynamics between the laminated films depends on various parameters, such as the processing condition, polymer molecular weight, and chain mobility. The key attributes of our composite laminated films are first the entire process is carried out at room temperature, and second it is accomplished using water as solvent. Based on these features and by taking the advantages of the diffusion capacity of the CA and Ag chains at the dynamic interfacial layer, a dynamic network reorganization of the CAAlg network via molecular binding is achieved. Since both CA and Ag are water soluble and no chemical crosslinks exists between them, they should be able to move from one surface and penetrate the other with minimal restrictions. Also, the use of calcium ions for surface activation, due to its ionic interaction potential, should expedite the diffusion bonding of the polymer chains at the joining surfaces. These two processes maybe be expected to occur simultaneously, but at different rate, resulting in bonding of the composite films. To get a deeper quantitative understanding of the interfacial cohesion property of the CAAlg laminated composites, a single lap shear test was conducted on test specimen comprising of two CAAlg composite films bonded over a well-defined area. Then two glass slides containing the CAAlg film were bonded at the CAAlg surface using the semi-wet process by spraying an aqueous solution of 150 mM CaCl₂) to yield the test object that had two glass slides bonded via the CAAlg interface as depicted in FIG. 5c. This test configuration was adopted to avoid extraneous damage to the films due to excessive pressure at the grip during testing. As is evident from FIG. 5d, the bonding between the CAAlg film interface is adequate to support loading perpendicular to the bonding interface. FIG. 5e shows a typical lap shear curve of the bonded CAAlg interface.

In all the tested samples (5 samples), up on subjecting to loading, the failure always occurred in the region bEween the film and the glass substrate, indicating that the mechanical interlocking, ionic interaction, and other intramolecular interactions contribute to the cohesion forces between the two films, i.e., the bonding energy between the CAAlg surfaces exceeded the adhesion forces between the tape and the glass substrate. To gain quantitative insights, the shear strength was calculated from the force-displacement curves of samples of 100 mm2 overlap area using equation 1 (Table 1).

$${T}_{b} = \frac{F}{L \times W} \qquad Equation ( 1 )$$

where F is the ultimate force, L and W are respectively the length and width of joint.

TABLE 1
Lap shear test property of the CAAlg composite joints.

| | | | Force | Displacement | Lap shear |
|---|---|---|---|---|---|
| Sample | L(mm) | W(mm) | (N) | (mm) | strength (KPa) |
| CAAlg-150 | 10 | 10 | 13.2 ± 0.81 | 1.2 ± 0.05 | 132.9 ± 8.13 |

The CAAlg composite possessed an average lap shear strength of around 132.9 kPa and an average value for the failure load of the interface of 13.2±0.81 N, and this value is similar to the ultimate load values obtained from the uniaxial tensile testing of CAAlg-150 composite films (10.09±1.47 N). This result reveals that the newly formed interface between CAAlg films is physicochemically consistent to the bulk of the CAAlg composite. This bodes well for the further development of CAAlg polysaccharide composites in the realm of environmentally friendly structured laminates in combination with wood-based and clay-based materials.

Processing of CAAlg Using Printing into Films and Adhesive Interfaces for Bonding Natural Materials

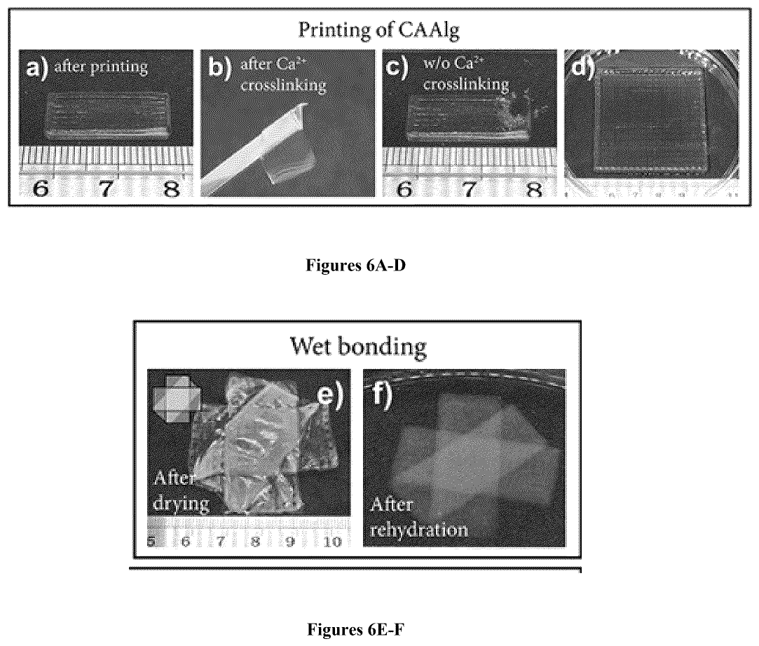

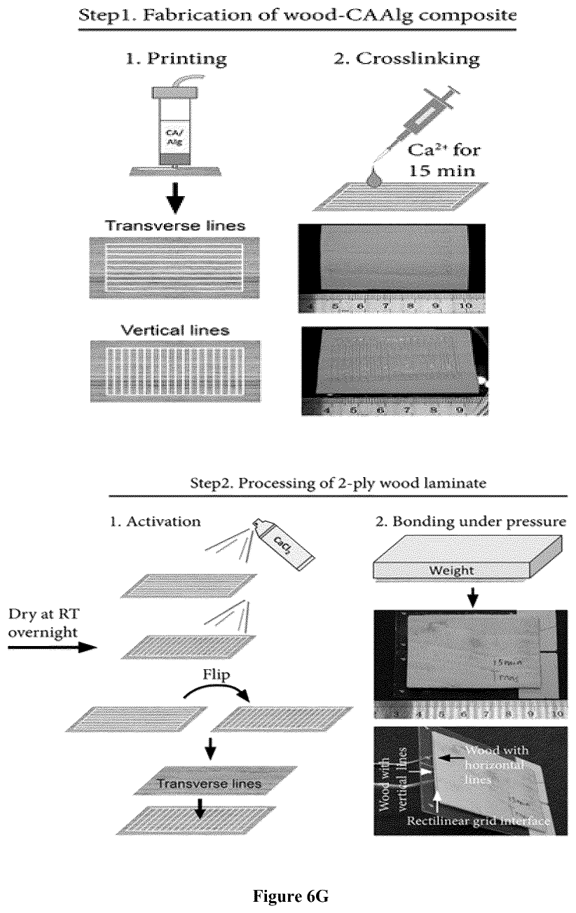

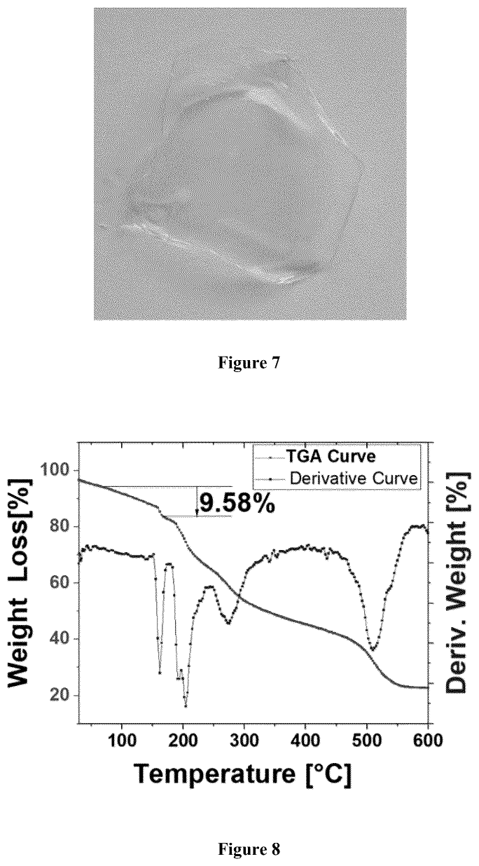

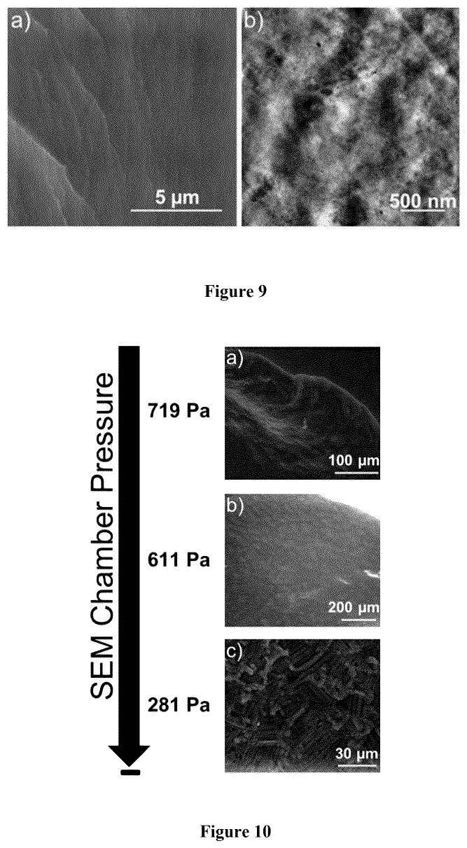

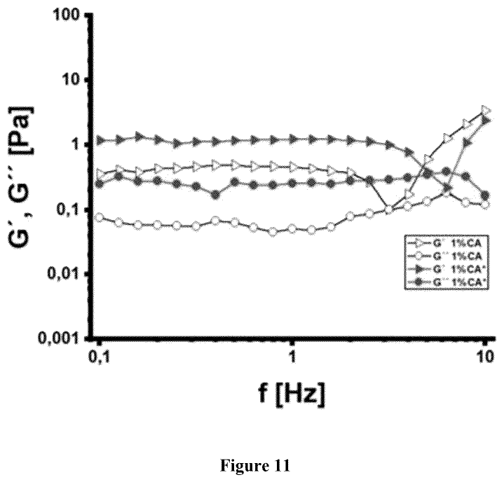

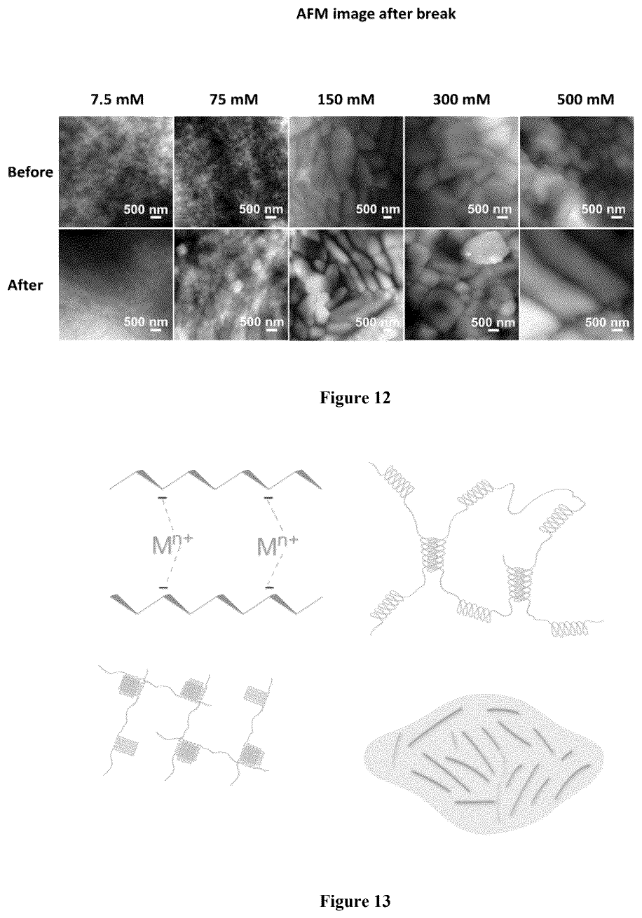

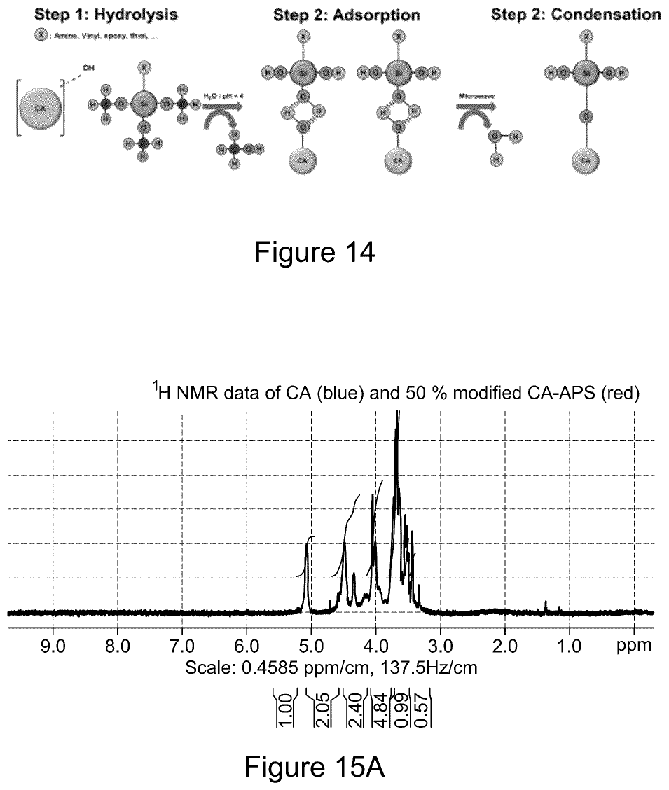

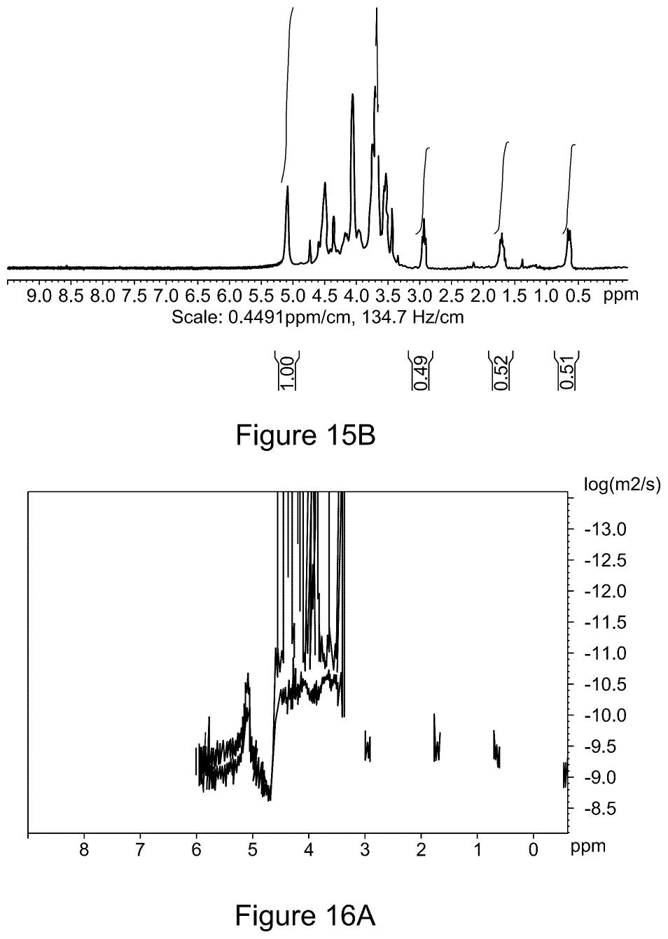

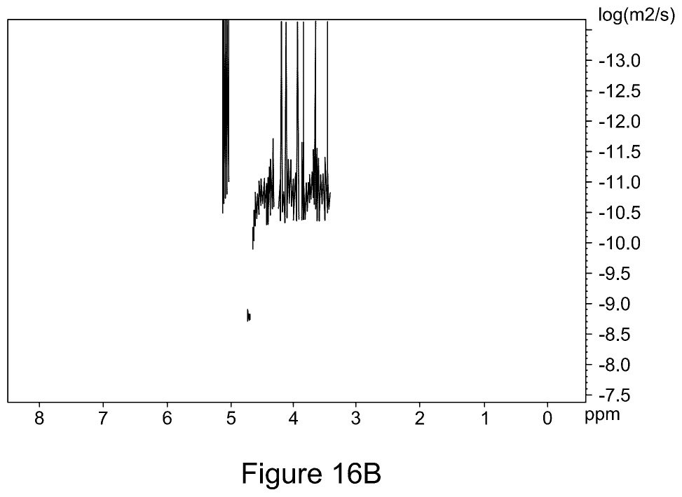

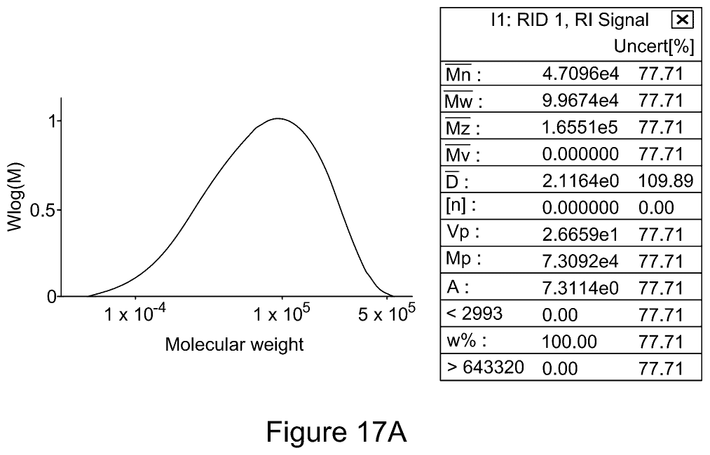

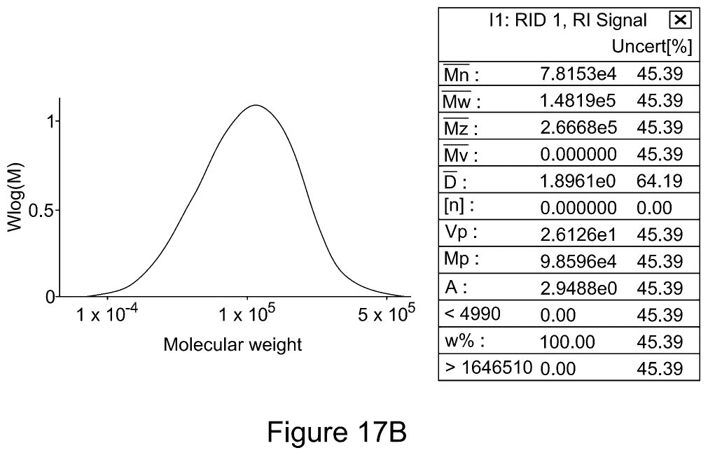

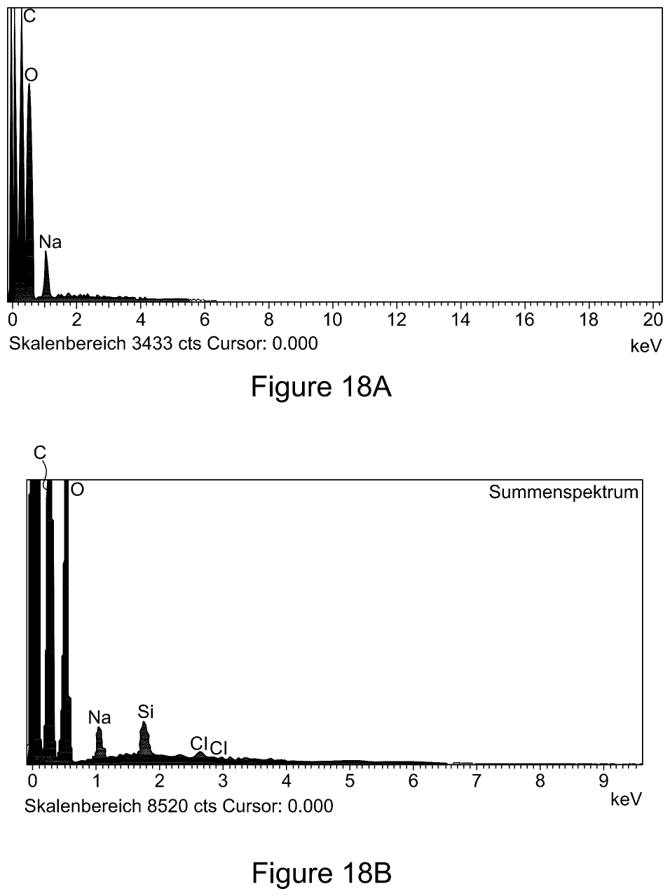

To illustrate further the potential of CAAlg composite films in engineering of materials, we used extrusion-based printing as a processing strategy as it has utility in many mundane and emerging applications. Using a previously established printing regimen for printing CA bioinks (44), we successfully printed a 1.5-mm thick rectangular sheet (FIG. 6a), and this sheet upon crosslinking with CaCl₂) solution, yielded physically stable CAAlg-150 films that showed adequate mechanical integrity to be handled by a spatula (FIG. 6b). In contrast, films that were not crosslinked with calcium could not be manipulated and disintegrated when picked up (FIG. 6c) providing further evidence for the importance of the ionically cross-linked network in imparting mechanical properties to the CAAlg films. Building on this success, structures ranging from a square rectilinear grid (FIG. 6d) to a 3-ply crisscross pattern of rectangularly shaped CAAlg-150 films bonded using wet-bonding immediately following printing (FIG. 6e) were also realized. The 3-ply film interface showed remarkable integrity following drying and did not delaminate upon rehydration for 72 h demonstrating the permanency and robustness of the bonded layers (FIG. 6f).

To explore the wet-bonding paradigm demonstrated in FIG. 5 in the fabrication of structural composites derived from natural materials, the fabrication of 2-ply wood laminate was explored as an example. Two wood panels were patterned respectively, with transverse and vertically space array of lines using extrusion printing, and then crosslinked with calcium to yield wood-CAAlg-150 composites as illustrated in the workflow in FIG. 6g. The dried CAAlg-150 modified surface of the dried panels were then activated with a spray of calcium solution and the panels were assembled under pressure to yield a 2-ply wood laminate that was firmly bonded via the rectilinear interface of CAAlg-150 composite (FIG. 6g, right panel). This demonstrates the ability to process composites of natural materials using marine polysaccharides and water containing divalent cations as the processing agent.

In conclusion, here we present a strategy to realize marine polysaccharide-based composites that exhibit properties that exceed that of PLA a semi-crystalline, degradable polymer with significant use in circular economy. This was accomplished through the realization of a double-IPN comprising of physical and ionic crosslinks, thus avoiding traditional chemical crosslinking strategies that have adverse impact on the environment. The possibility to process CAAlg composite films by casting or printing from aqueous medium, and further post-process these films into laminates using a water-based semi-wet process opens up numerous opportunities for these materials in applications such as a bonding layer in the fabrication of panels and flooring based on other natural products such as wood as already demonstrated, gypsum and clay-based materials, as moisture or heat sink, or as a matrix to incorporate microbicidal and antifungal agents to prevent biofouling in building materials. These materials can also be used in packaging and bonding applications, for example, as a glue to form composite materials, with wood, carbon fiber, clay, metals such as steel, aluminum, and copper, including metal foils, plastics, polymer films, for example, polyethylene, polypropylene, mylar, polycarbonate, polyethylene terephthalate and the like, tiles (for example, clay, ceramic or brick), paper, cotton, or other cellulosic materials, and combinations thereof. xav

### Materials and Methods

Materials: Sodium Alginate (Alg) was purchased from the Carl Roth Germany (300-350 103 g/mol), while the carboxylated agarose (CA), the medium CA (G′, 2270±864 Pa) and the soft CA (G′, 16±0.62 Pa) was synthesized in our lab, using native agarose (NA) type 1 (GeneOn, Germany) as previously described by Forget et al. (37). Calcium chloride (CaCl₂)) (Mw=110.99 g/mol) was purchased by the Sigma-Aldrich. All reagents were dissolved in MilliQ water and used without any previous purification. Film fabrication: All the films were prepared by sol-gel casting process (evaporation technique). For mechanical testing dried film was peeled out gently and cut to the appropriate shape using a doctor blade. Preparation of CA films: The carboxylated agarose with two different storage modulus (medium 386 CA: G′, 2270±864 Pa; Mn, 7.8 104 g/mol; ÐD=2.0; soft CA: G′, 16±0.62 Pa; Mn, 6.98 104 g/mol; Ð=2.1) were dissolved in dionized water at 90° C. to obtain a 5 wt % carboxylated agarose solution. In the meantime a Petri dish (f 10 cm) was cooled by placing it in a fridge at 7° C. for 10 min. 5 mL of the CA mixture was poured in the pre-cooled Petri dish. Afterwards the Petri dish was placed in cooled water bath at a temperature of 10° C. and left for 15 min. Finally the resulting film was dried inside the hood at room temperature for 3 days. Preparation of the alginate crosslinked with calcium: [Ca2+] crosslinked alginate films were prepared by dissolving the alginate sodium salt in dionized water at 90° C. at a concentration of 5 wt %. Five mL of the mixture was poured into Petri dish (f 10 cm) and then cooled down to room temperature. In order to crosslink the film 5 mL of CaCl₂ (150 mM) was added on top of the film and left for 15 min following which the calcium chloride solution was pipeted out and the surface of the film was dabbed using a lint free tissue paper. The film was covered to prevent dust contamination and then dried in at room temperature in a fume hood for 3 days.

Preparation of CAAlg film

As depicted in FIG. 1, the CAAlg composite film was prepared as follows: CA soft (0.37 g), CA medium (0.37 g) and Alg (0.25 g) were mixed together at 90° C. in 20 mL of MilliQ water, until a clear solution was obtained, resulting in a mixture of 5% w/v concentration. The above mixture was subsequently transferred into a pre-cooled petri dish placed on an ice bath (10° C.) and spread using a gentle circular tilting motion to uniformly distributed the solution on the petri dish surface. Once the solution had gelled, CaCl₂ was added on the top of the film, in order to crosslink Alg. After 15 min the calcium chloride solution was pippeted out and the surface of the film was gently dabbed with lint free tissue paper to remove any remaining liquid. The film was covered to prevent dust contamination and then dried at room temperature in a fume hood for 72 hours.

### Preparation of the Laminated CAAlg Films

The laminated films were prepared by rehydrating three independent CAAlg-150 film surfaces using 150 mM calcium chloride solution. These films were pressed together (20 mm×20 mm overlapping area) using glass slides and sedured using pinch clamps and dried for 3 days in the hood at room temperature and 35% humidity. Printing of CAAlg films and fabrication of wood-laminates: Printing CAAlg films: Printing of CAALg films was carried out using an in-house modified Inkredible+ 3D bioprinter (Cellink, Stockholm, Sweden) with modifications as previously described (44). The CAAlg composite was prepared by dissolving CA and alginate with dH₂O in a closed syringe in 95° C. water bath. Solution of CAAlg blend was then transferred to a cartridge preheated to 37° C. and equilibrated for 10 minutes. Predesigned 1.5-mm high rectangular constructs (8 mm×20 mm, 25 mm×50 mm, and 50 mm×50 mm) were printed on a printing platform that was cooled and maintained at 4° C. followed by in situ crosslinking with 150 mM CaCl₂ solution. For bonding of printed films, immediately after calcium crosslinking wet-CAAlg films were picked up and stacked in criss-cross pattern to form a central region containing 3-layers and then dried overnight.

### Fabrication of Wood-Laminate

Wood veneers (panels) were first affixed to glass slides using double-sided tape to provide an even surface for printing and to also ensure that the wood panel does not move during the printing. In order to realize a rectilinear grid bonding pattern between the wood panels, two rectangular (50 mm×25 mm) wood panels were patterned using printing with transversely (horizontally)-spaced lines, i.e., parrallel to the length, and with vertically spaced i.e., perpendicular to the length to yield CAAlg-patterned wood. The line width was 300 μm, height 500 μm and spacing between lines was 1 mm. After printing, the patterns were crosslinked by immersing the pattern in 150 mM CaCl₂ solution and the wood panels were dried at ambient temperature overnight. The CAAlg pattern on the wood panels were activated by spraying a solution of CaCl₂ and then assembled with horizontally and vertically-patterned surfaces facing each other and then dried overnight under pressue to yield a 2-ply wood panel with a rectilinear grid of CAAlg as the bonding interface.

### Scanning Electron Microscopy Imaging (SEM)

Scanning electron micrographs of the composite film (CAAlg) and the controls (Alg and CA) were obtained, using Quanta 250 FEG Scanning Electron Microscope (Fei,USA) equipped with a field emission gun (20 kV at 100 Pa). The film sample was frozen in liquid nitrogen and dissected into pieces. Side view images of the interior of the film with different magnification was reproduced. The samples for the CaCl₂ were prepared using 1 ml of solution droped in aluminum foil, followed by drying overnight in the oven at 80° C. Atomic Force Microscopy (AFM): AFM images were obtained, using the atomic force microscope diNanoscope V (Brucker AXS, Germany) in tapping mode, equipped with cantilever RTESP (Bruker AXS) and data were processed using the Gwyddion SPM data visualization and analysis tool (2.56,2020). Films were also imaged both before and after uniaxial deformation.

### Mechanical Testing

The mechanical properties were evaluated using the Z005 machine from Zwick Roel with 100 N Load cell and 25 mm Gauge length. The testing speed was 1 mm min-1. The specimens have a size of 60 mm×50 mm×20-50 μm. At least ten samples were tested at room temperature and humidity.

### Lap Shear Test

The Laminated pattern were prepared using two CAAlg-150 composite individual films. First the test specimen was prepared by first affixing a CAAlg film to the glass substrate using adhesive tape and the tape was then trimmed to ensure no contact between it and the second glass surface. Then the film surfaces were activated using 150 mM CaCl₂ solution, and stacked together with an overlapping area of 10 mm×10 mm. Finally, they were laminated together using glass slides, and joint pinch clamps and dried for 3 days in the hood at room temperature. Five specimens were evaluated using tensile lap shear test with the same parameter as for the previous tensile test, and the data were studied as force/displacement curves.

### Environmental Scanning Electron Microscopy (ESEM)

ESEM micrographs were obtained using INCA-X Act (Oxford Instrument). 5% (w/v) of CAAlg-150 gel was prepared and micrograph of the wet sample with different chamber pressure and magnification were recorded.

### Optical Microscopy

The samples were prepared as follows: 1 ml of freshly prepared CaCl₂ sample were dropped between two microscope cover slips and dried on the oven overnight at 80 467° C.

### Moisture Uptake (MO %)

MO uptake measurement were carried out using a gravimetric method. Dry Film samples were weighed using a digital analytical scale then transferred to a pre-set humid chamber prepared as the following: A tightly closed chamber contains a saturated solution of 500 ml of 2M Na2SO4 and 500 ml of Milli-Q water was left for 24 h to reach equilibrium of 96% humidity at 23° C. The relative moisture uptake (MO %) was calculated over period up to 24 h according to the equation (2):

$$MO ( \% ) = \frac{{m}_{t} - {m}_{1}}{{m}_{t}} \times 100 \qquad Equation ( 2 )$$

where ml is the initial dry mass of the film and mt the film mass at time t.

### Thermal Gravimetric Analysis

Thermal gravimetric analysis (TGA) results were performed on the Simultaneous TGA-DSC STA 409 CD device from NETZSCH. Three different 150 mM CAAlg films were subjected to a controlled heat program (27-600° C., 10° C. per minute, under air atmosphere), and the loss of mass of the sample was recorded as function of the temperature. The 1st order derivative curve was obtained using origin program (OriginPro 2020 SRi 9.7.188).

### Rheology Measurement

Rheological characterizations were conducted on a Kinexus Pro+ rotary rheometer (KNX2212, MALVERN) equipped with a cone and plate assembly comprising an upper 4 cone plate 40 mm in diameter. Sample for rheological measurement was prepared as follows: 1% of CA blend sample was first dissolved at 90° C. water bath until a clear solution was obtained before storing in the fridge for 1 h to form the gel, then transferred to 25° C. water bath for 1 h to let the sample reach equilibrium. Every sample was split into two different sample, before adding a 1% (v/v %) of 150 mM [Ca2+] solution to one sample, and 1% of Milli-Q water to the other sample. For the frequency sweep measurements, the sample was loaded on to the lower plate at 25° C. and maintained at that temperature for 5 min to equilibrate, afterwards a frequency sweep test from 10 Hz to 0.1 H was carried out. The result is represented as storage modulus G′ as function of the appropriate frequency.

### REFERENCES

1. M. Cordella, R. Kaps, “Sustainability of Bio-based Products: Linking Life Cycle Thinking with Standards, Certification and Labelling Schemes” in Designing Sustainable Technologies, Products and Policies From Science to Innovation, E. Benetto, K. Gericke, M. Guiton, Eds. (Springer Open, 2018), 10.1007/978-3-319-66981-6_57, pp. 469-474.
2. V. Mannheim, Z. Simenfalvi, Total Life Cycle of Polypropylene Products: Reducing Environmental Impacts in the Manufacturing Phase. Polymers-Basel 12 (2020).
3. P. Ramesh, S. Vinodh, State of art review on Life Cycle Assessment of polymers. Int J Sustain Eng 13, 411-422 (2020).
4. W. F. Carroll, Comment on “Sustainability Metrics: Life Cycle Assessment and Green Design in Polymers”. Environ Sci Technol 45, 5054-5054 (2011).
5. G. David et al., Using life cycle assessment to quantify the environmental benefit of upcycling vine shoots as fillers in biocomposite packaging materials. Int J Life Cycle Ass 26, 738-752 (2021).
6. C. L. Reichert et al., Bio-Based Packaging: Materials, Modifications, Industrial Applications and Sustainability. Polymers-Basel 12 (2020).
7. F. M. Lamberti, L. A. Roman-Ramirez, J. Wood, Recycling of Bioplastics: Routes and Benefits. J Polym Environ 28, 2551-2571 (2020).
8. L. Shen, M. K. Patel, Life Cycle Assessment of Polysaccharide Materials: A Review. J Polym Environ 16, 154-167 (2008).
9. C. J. Chen, D. Y. W. Ng, T. Weil, Polymer bioconjugates: Modern design concepts toward precision hybrid materials. Prog Polym Sci 105 (2020).
10. C. Johansson et al., Renewable Fibers and Bio-Based Materials for Packaging Applications—a Review of Recent Developments. Bioresources 7, 2506-2552 (2012).
11. R. Shogren, D. Wood, W. Orts, G. Glenn, Plant-based materials and transitioning to a circular economy. Sustain Prod Consump 19, 194-215 (2019).
12. B. Aaliya, K. V. Sunooj, M. Lackner, Biopolymer composites: a review. International Journal of Biobased Plastics 3, 40-84 (2021).
13. R. P. Babu, K. O'Connor, R. Seeram, Current progress on bio-based polymers and their future trends. Prog Biomater 2, 8 (2013).
14. D. S. Cha, M. S. Chinnan, Biopolymer-based antimicrobial packaging: a review. Crit Rev Food Sci Nutr 44, 223-237 (2004).
15. T. Ojeda, Polymers and the Environment. F. Yilmaz, Ed., Polymer Science (IntechOpen, London, 2013), 10.5772/51057.
16. A. Morao, F. de Bie, Life Cycle Impact Assessment of Polylactic Acid (PLA) Produced from Sugarcane in Thailand. J Polym Environ 27, 2523-2539 (2019).
17. D. El Chami, A. Daccache, M. El Moujabber, What are the impacts of sugarcane production on ecosystem services and human well-being?A review. Ann Agr Sci-Cairo 65, 188-199 (2020).
18. Z. Q. Pang et al., Continuous Sugarcane Planting Negatively Impacts Soil Microbial Community Structure, Soil Fertility, and Sugarcane Agronomic Parameters. Microorganisms 9 (2021).
19. J. Prasara, S. H. Gheewala, Sustainability of sugarcane cultivation: case study of selected sites in north-eastern Thailand. J Clean Prod 134, 613-622 (2016).
20. P. J. Thorburn, J. S. Biggs, S. J. Attard, J. Kemei, Environmental impacts of irrigated sugarcane production: Nitrogen lost through runoff and leaching. Agr Ecosyst Environ 144, 1-12 (2011).
21. V. V. Devadas et al., Algae biopolymer towards sustainable circular economy. Bioresource Technol 325 (2021).
22. T. Wüstenberg, “General Overview of Food Hydrocolloids” in Cellulose and Cellulose Derivatives in the Food Industry—Fundamentals and Applications, T. Wüstenberg, Ed. (Wiley-VCH Verlag GmbH & Co. KGaA, 2014), 10.1002/9783527682935, pp. 1-68.
23. T. D. Phan, F. Debeaufort, D. Luu, A. Voilley, Functional properties of edible agar-based and starch-based films for food quality preservation. J Agr Food Chem 53, 973-981 (2005).
24. J. R. Rodriguez-Nunez, T. J. Madera-Santana, D. I. Sanchez-Machado, J. Lopez-Cervantes, H. S. Valdez, Chitosan/Hydrophilic Plasticizer-Based Films: Preparation, Physicochemical and Antimicrobial Properties. J Polym Environ 22, 41-51 (2014).
25. Y. Zhang, Processing and Development of Polysaccharide-Based Biopolymers for Packaging Applications (Elsevier, ed. 1st, 2020).
26. P. A. Guerette et al., Nanoconfined β-Sheets Mechanically Reinforce the Supra-Biomolecular Network of Robust Squid Sucker Ring Teeth. ACS Nano 8, 7170-7179 (2014).
27. D. Ding et al., Biomimetic production of silk-like recombinant squid sucker ring teeth proteins. Biomacromolecules 15, 3278-3289 (2014).
28. S. H. Hiew et al., Squid Suckerin Biomimetic Peptides Form Amyloid-like Crystals with Robust Mechanical Properties. Biomacromolecules 18, 4240-4248 (2017).
29. S. Amini, M. Tadayon, S. Idapalapati, A. Miserez, The role of quasi-plasticity in the extreme contact damage tolerance of the stomatopod dactyl club. Nat Mater 14, 943-950 (2015).
30. J. C. Weaver et al., The stomatopod dactyl club: a formidable damage-tolerant biological hammer. Science 336, 1275-1280 (2012).
31. L. H. Sperling, “Interpenetrating Polymer Networks: An Overview” in Interpenetrating Polymer Networks, D. e. a. Klempner, Ed. (American Chemical Society, 1994), 10.1021/ba-1994-0239.ch001 chap. 1, pp. 3-38.
32. J. Y. Sun et al., Highly stretchable and tough hydrogels. Nature 489, 133-136 (2012).
33. G. Milczarek, O. Inganas, Renewable cathode materials from biopolymer/conjugated polymer interpenetrating networks. Science 335, 1468-1471 (2012).
34. D. H. Nagaraju et al., Charge Storage Capacity of Renewable Biopolymer/Conjugated Polymer Interpenetrating Networks Enhanced by Electroactive Dopants. Advanced Energy Materials 4 (2014).
35. D. Chimene et al., Nanoengineered Ionic-Covalent Entanglement (NICE) Bioinks for 3D Bioprinting. ACS Appl Mater Interfaces 10, 9957-9968 (2018).
36. C. B. Rodell, N. N. Dusaj, C. B. Highley, J. A. Burdick, Injectable and Cytocompatible Tough Double-Network Hydrogels through Tandem Supramolecular and Covalent Crosslinking. Adv Mater 28, 8419-8424 (2016).
37. H. Y. Wang et al., Covalently Adaptable Elastin-Like Protein-Hyaluronic Acid (ELP-HA) Hybrid Hydrogels with Secondary Thermoresponsive Crosslinking for Injectable Stem Cell Delivery. Adv Funct Mater 27 (2017).
38. A. Ruther et al., Unravelling a Direct Role for Polysaccharide beta-Strands in the Higher Order Structure of Physical Hydrogels. Angew Chem Int Ed Engl 56, 4603-4607 (2017).
39. D. J. Adams, Does Drying Affect Gel Networks?Gels-Basel 4 (2018).
40. J. Giron-Hernandez, P. Gentile, M. Benlloch-Tinoco, Impact of heterogeneously crosslinked calcium alginate networks on the encapsulation of beta-carotene-loaded beads. Carbohyd Polym 271 (2021).
41. A. Forget et al., Polysaccharide hydrogels with tunable stiffness and provasculogenic properties via alpha-helix to beta-sheet switch in secondary structure. P Natl Acad Sci USA 110, 12887-12892 (2013).
42. S. J. Liu, H. J. Li, B. J. Tang, S. G. Bi, L. Li, Scaling law and microstructure of alginate hydrogel. Carbohyd Polym 135, 101-109 (2016).
43. K. Potter, B. J. Balcom, T. A. Carpenter, L. D. Hall, The Gelation of Sodium Alginate with Calcium-Ions Studied by Magnetic-Resonance-Imaging (Mri). Carbohyd Res 257, 117-126 (1994).
44. Anonymous (PLA (polylactic acid) Technical Data Sheet. (SD3D.com, https://www.sd3d.com/wp-content/uploads/2017/06/MaterialTDS-PLA_01.pdf).
45. Anonymous (NatureWorks® Ingeo™ 4043D General Purpose Film Grade Biopolymer. (MatWeb, https://www.matweb.com/search/DataSheet.aspx?MatGUID=3d02fe1863124a24a039a2c853972fc6).
46. Anonymous (Overview of materials for Low Density Polyethylene (LDPE), Film Grade. (MatWeb, https://www.matweb.com/search/DataSheet.aspx?MatGUID=9ff98d958a714b2a8a00990a929d6f14).
47. R. K. Krishnaswamy, M. J. Lamborn, Tensile properties of linear low density polyethylene (LLDPE) blown films. Polym Eng Sci 40, 2385-2396 (2000).
48. F. Li, D. H. Bae, A. K. Ghosh, Grain elongation and anisotropic grain growth during superplastic deformation in an Al—Mg—Mn—Cu alloy. Acta Mater 45, 3887-3895 (1997).
49. Y. Gu et al., Advanced Bioink for 3D Bioprinting of Complex Free-Standing Structures with High Stiffness. Bioengineering (Basel) 7 (2020).
50. J. C. Hua, P. F. Ng, B. Fei, High-strength hydrogels: Microstructure design, characterization and applications. J Polym Sci Pol Phys 56, 1325-1335 (2018).

### Example 2: Double Interpenetrating Networks of K-Carrageenan/Alginate

The goal of this example was to compare the results of the carboxylated agarose (CA)/alginate system (CAAlg) in Example 1 with a system where the physical crosslinks provided by carboxylated agarose is now conferred by carrageenan. In this system, kappa carrageenan, upon exposure to monovalent cations like potassium and sodium (potassium works far more efficiently that sodium) undergoes physical gelation leading to the physical crosslinks.

In this system, the function and role of alginate is the same as in the CAAlg system. The film casting procedure is similar, with a minor difference being potassium chloride solution is added to CA/k-carrageenan to induce gelation of the carrageenan phase, the solution is then cast into a film and the further ionically crosslinked using divalent cations, namely, calcium. In addition to [Ca²⁺] ranging from 250-500 mM, lower concentrations of 10-150 mM were also explored.

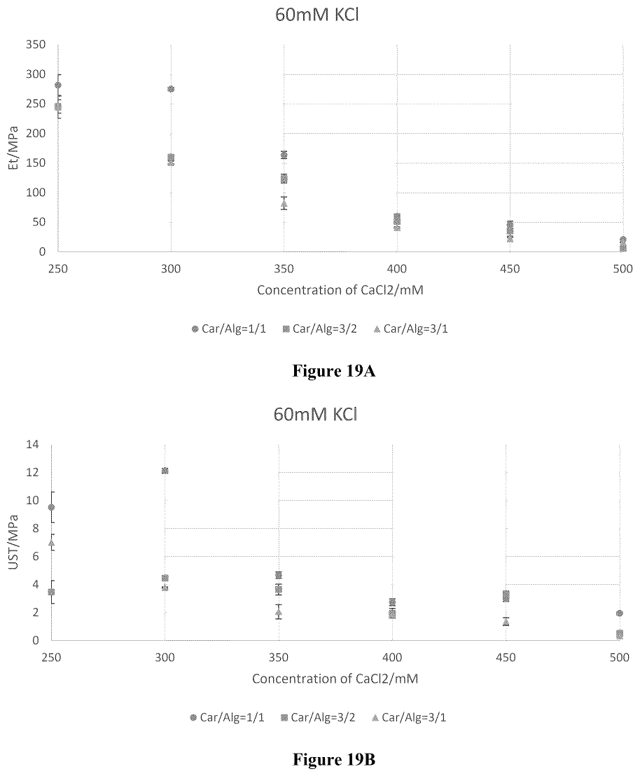

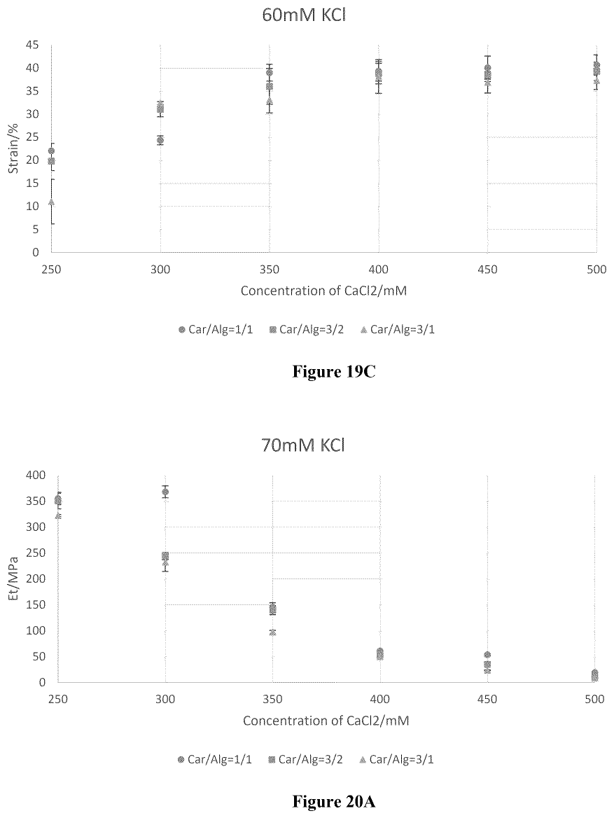

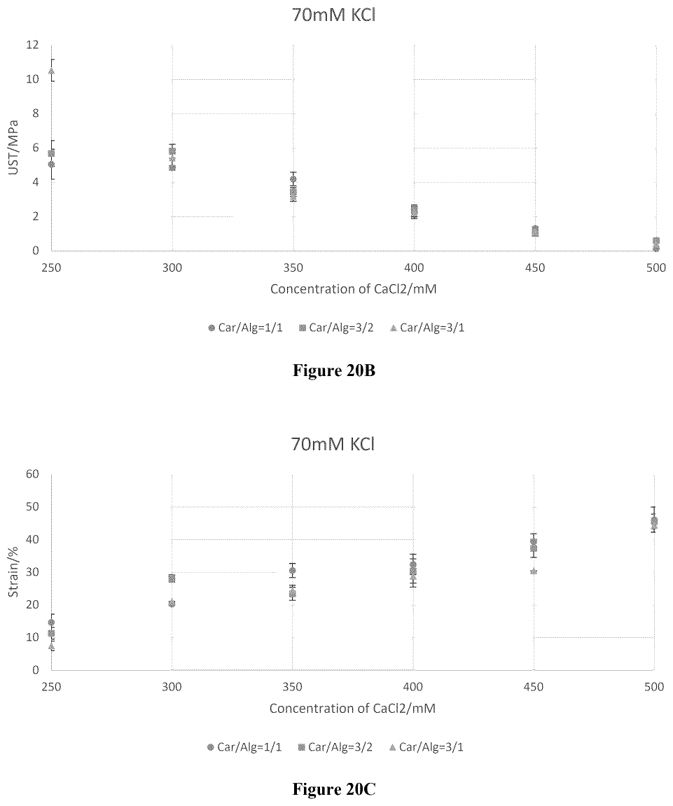

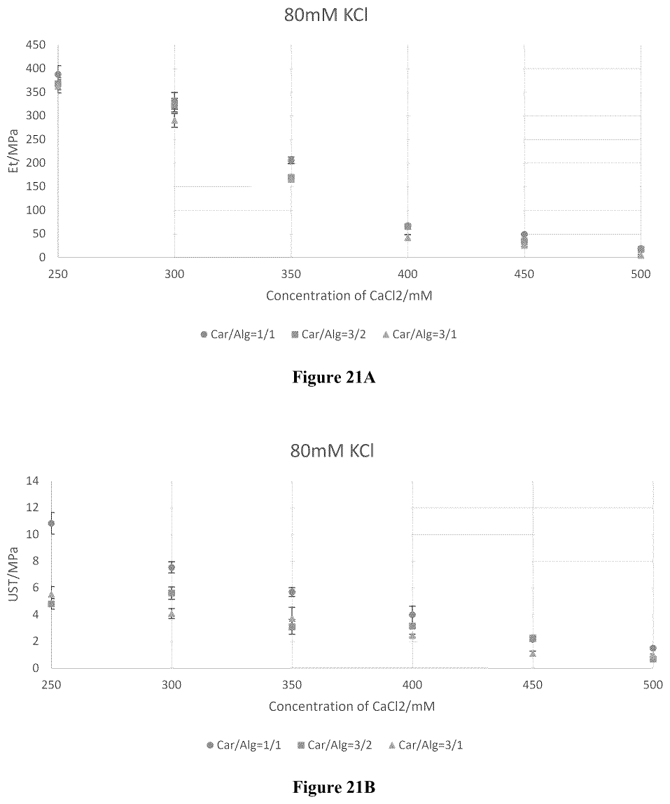

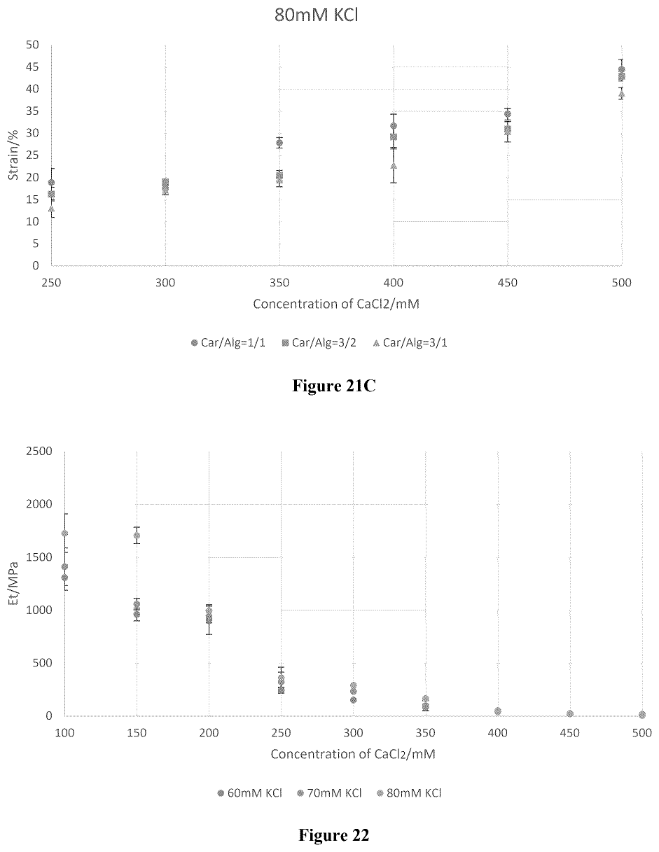

To assess the specific contributions of components kappa carrageenan and alginate to the mechanical properties, the ratio between them was systematically modified. This involved varying the ratios of kappa carrageenan and alginate in relation to 3/1, 3/2, and 1/1, respectively. FIGS. 19A-C, 20A-C and 21A-C show how the mechanical properties change after alternating the ratio of kappa carrageenan and alginate, as well as concentration of KCl solution, where the concentration of CaCl₂ is kept in 250 mM. In FIGS. 19A-C, the KCl concentration is 60 mM, and the Young's modulus (Et/MPa), ultimate tensile strength (UTS/MPa) and strain (Strain/%), respectively, were measured. FIGS. 20A-C and 21A-C are the same as FIGS. 19A-C, except that the KCl concentration is 70 mM or 80 mM, respectively.

When the concentration of KCl and CaCl₂ remains unchanged, the value of Young's modulus generally increases as the proportion of alginate increases. This may be because with the increasing amount of alginate, more Ca²⁺ crosslinks and bridges are formed which can dissipate stress more efficiently and a network structure that can yield films that are stronger and tougher. The change in the UTS and Eₜ with varying concentrations of potassium and calcium ions (and the same would be expected with other monovalent and divalent cations) shows similar trends, as shown in FIGS. 19-A-C, 20A-C and 21A-C, and both of these properties can vary with the proportion of alginate used, to increase the strength of the film. For the strain, when the amount of alginate increases, these values also increase. As a result, adding more alginate results in more flexible films.

FIG. 22 is a chart showing the Eₜ value changes with different concentration of KCl and CaCl₂ solution. As larger concentrations of CaCl₂ are used to ionically crosslink the κ-carrageenan/alginate films, the elastic modulus value decreases. Further, as the concentration of CaCl₂ is lowered, the KCl has a more significant influence.

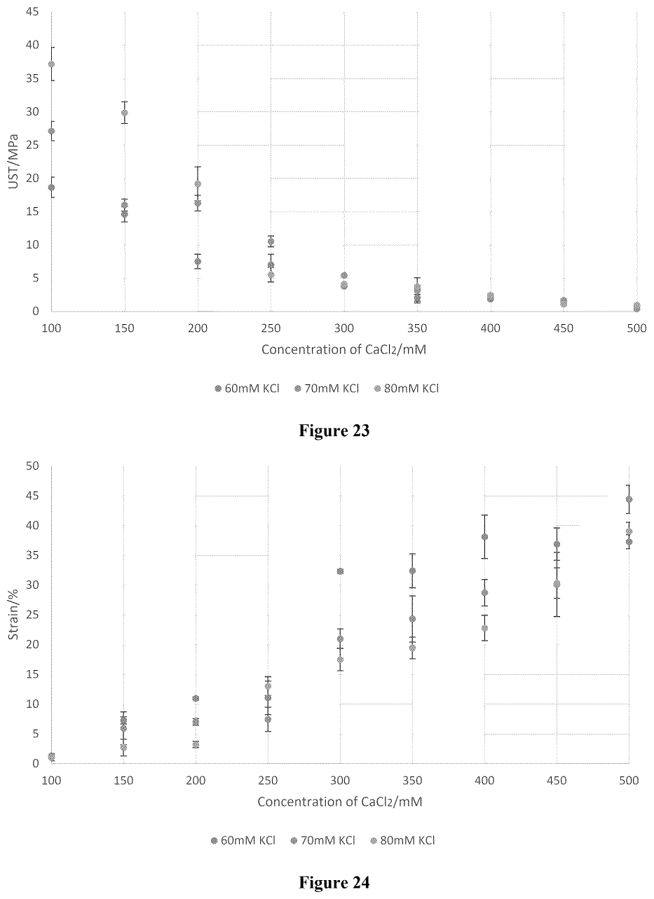

FIG. 23 is a chart showing how universal tensile stress changes with different concentration of KCl and CaCl₂ solutions. As shown in FIG. 23, the trend is similar to the change of Eₜ value shown in FIG. 22.

FIG. 24 is a chart showing how the strain changes with different concentration of KCl and CaCl₂ solutions. Overall, the chart shows a trend of increasing strain as the concentration of calcium and/or potassium ions increase.

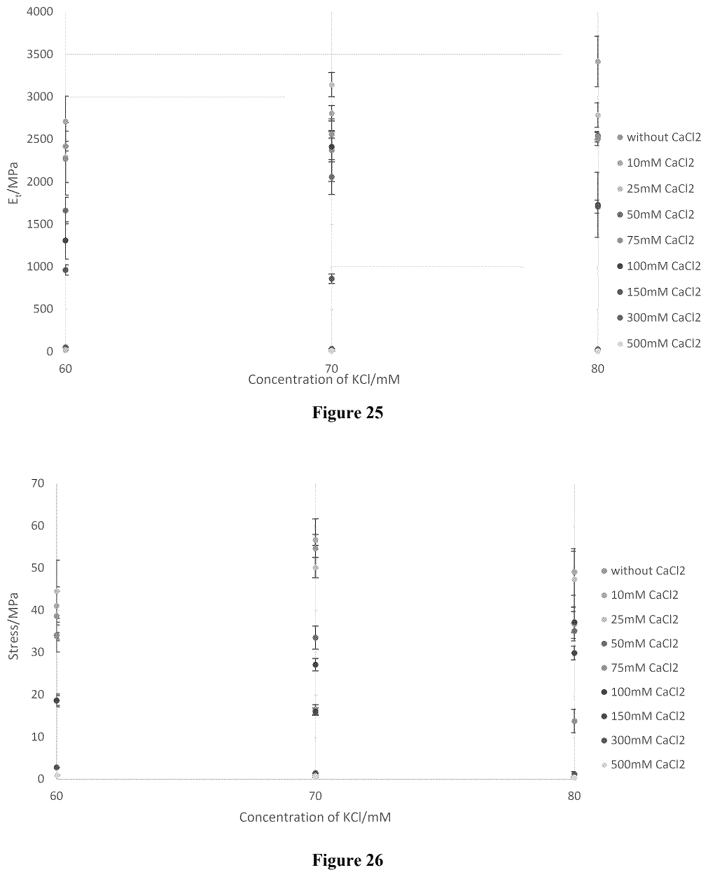

FIG. 25 shows the change in elastic modulus with different concentrations of CaCl₂ and KCl solutions. The X-axis shows different concentrations of KCl (60 mM, 70 mM and 80 mM)), and different colors show different concentrations of CaCl₂ (where orange shows results without adding CaCl₂). As this figure shows, both concentrations influence the Eₜ value, and the influence of CaCl₂ solution is more significant.

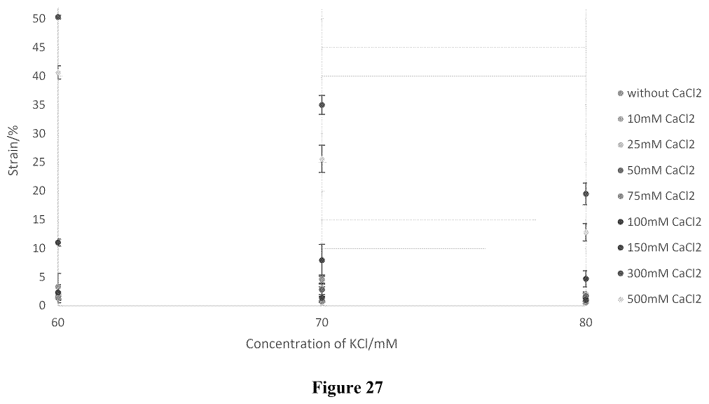

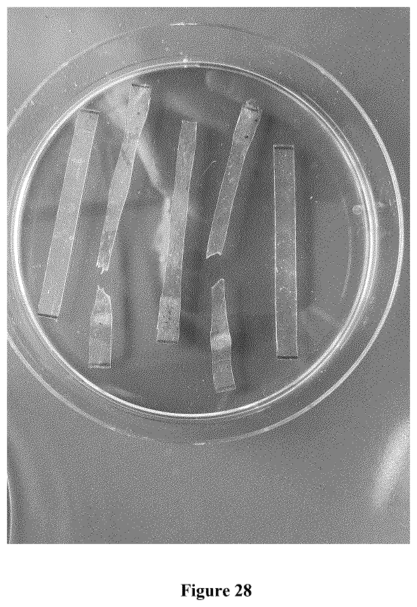

FIG. 26 is a chart showing the change in stress (stress/MPa) with different concentration of CaCl₂ and KCl solutions. The X-axis refers to different concentration of KCl (60 mM, 70 mM and 80 mM)), and different colors denote different concentration of CaCl₂ (the orange one shows the result without adding CaCl₂).

FIG. 27 is a chart showing the changes in strain as a function of different concentrations of CaCl₂ and KCl solution. The X-axis shows different concentration of KCl (60 mM, 70 mM and 80 mM)), and different colors denote the various concentrations of CaCl₂ (the orange one shows the result without adding CaCl₂). Films made using CaCl₂ concentration of 300 mM and 500 mM, the films have an remarkable ability to resist fracture, in that they can be stretched very long without breaking and exhbiti a property termed “necking,”, as shown in FIG. 28.

The present invention is not to be limited in scope by the specific embodiments described herein. Indeed, various modifications of the invention in addition to those described will become apparent to those skilled in the art from the foregoing description and accompanying figures. Such modifications are intended to fall within the scope of the appended claims.

Various publications are cited herein, the disclosures of which are incorporated by reference in their entireties.

1. A multi interpenetrating network of marine polymers, comprising:
one or more marine polymer capable of physically crosslinking and one marine polymer capable of ionically crosslinking,
wherein the marine polymer(s) capable of physically crosslinking is physically crosslinked in a manner that entraps the marine polymer(s) capable of ionically crosslinking, and
wherein the marine polymer(s) capable of ionically crosslinking is ionically crosslinked in a manner that entraps the marine polymer capable of physically crosslinking.

2. The dual interpenetrating network of claim 1, wherein the polymers are selected from the group consisting of alginates, carrageenans, ulvans, starches, agaroses, porphyrans, celluloses, and derivatives thereof, wherein the derivatives are polymers comprising one or more ionically-crosslinkable groups.

3. The dual interpenetrating network of claim 1, wherein the ionically-crosslinkable polymers comprise one or more ionically-crosslinkable groups selected from the group consisting of carboxylic acids, sulfonic acids, phosphoric acids, phosphinic acids, thiocarboxylic acids, and amines.

4. The dual interpenetrating network of claim 2, wherein one or more of the physically-crosslinkable and/or ionically-crosslinkable marine polymers comprises one or more covalently crosslinkable groups, and the covalently crosslinkable groups are crosslinked.

5. The dual interpenetrating network of claim 4, wherein the covalently crosslinkable groups are selected from the group consisting of epoxides, alcohols, phenols, aldehydes, amines, (meth)acrylic acid, (meth)acrylates, vinyl esters, vinyl ethers, vinyl sulfones, vinyl sulfonates, and thiol-enes, azide, acetylene, tetrazine, and cycloalkenes, such as cyclooctene.

6. The dual interpenetrating network of claim 4, wherein the covalently crosslinkable groups comprise (meth)acrylates, vinyl esters, vinyl ethers, vinyl sulfones, vinyl sulfonates, or thiol-enes, and the double penetrating polymer network is covalently crosslinked by free radical polymerization, either by crosslinking the groups with each other, or by crosslinking then with dienes, trienes, or polyenes on another monomer, oligomer or polymer.

7. The dual interpenetrating network of claim 4, wherein the covalently crosslinkable groups comprise epoxides, alcohols, phenols, aldehydes, and/or amines, and the covalently crosslinkable groups are crosslinked by condensation polymerization with a monomer, oligomer or polymer that comprises functional groups that react with the crosslinkable groups on the marine polymer in the double interpenetrating polymer network.

8. The dual interpenetrating network of claim 1, wherein at least one of the polymers is an agarose derivative comprising one or more ionically-crosslinkable groups, selected from the group consisting of carboxylic acids, sulfonic acids, phosphoric acids, phosphinic acids, thiocarboxylic acids, and amines.

9. The dual interpenetrating network of claim 1, wherein one of the physically-crosslinkable or ionically-crosslinkable marine polymers is an alginate, carrageenan, or agarose, or derivative thereof.

10. The double interpenetrating polymer networks of claim 1, wherein the polymers comprise one of the following combinations—two carboxylated agarose polymers, two carrageenans, or one carboxylated agarose polymer and one carrageenan.

11. A process for preparing a double interpenetrating network of marine polymers, comprising:
a) forming a solution comprising one or more marine polymers capable of physically crosslinking and one or more marine polymers capable of ionically crosslinking,
b) physically crosslinking the one or more marine polymers capable of physically crosslinking in a manner that physically entrains at least a portion of the one or more marine polymers capable of ionically crosslinking, and
c) ionically crosslinking the one or more marine polymers capable of ionically crosslinking in a manner that physically entrains at least a portion of the one or more marine polymers capable of physically crosslinking.

12-31. (canceled)

32. Double interpenetrating polymer networks prepared using the process of claim 11.

33. The double interpenetrating polymer networks of claim 1, wherein the networks comprise a filler.

34. The double interpenetrating polymer networks of claim 33, wherein the filler is selected from the group consisting of antimicrobial agents, clay, laponite, silicates, talc, graphene, carbon colloid, C60, carbon nanotubes metal nanotubes, metal “whiskers,” glass fibers, wood powder, saw dust, silica colloids, nanocellulose, nanocrystalline cellulose, and cellulose fibrils.

35. The double interpenetrating polymer networks of claim 34, wherein the antimicrobial agents are selected from the group consisting of ionic liquids, copper and silver colloids and salts, quaternary ammonium salts, polyphenols, and antimicrobial peptides.

36. Articles of manufacture prepared from the double interpenetrating networks prepared using the process of claim 11.

37. The articles of manufacture of claim 36, wherein the article of manufacture is selected from the group consisting of films, coatings, 3D printed objects, laminates, extruded articles, and cast articles.

38. The articles of manufacture of claim 37, wherein the article of manufacture is selected from the group consisting of packaging, disposable tableware, and utensils.

39. The article of manufacture of claim 36, wherein the article of manufacture is a composite material, comprising two or more layers formed of one or more materials selected from the group consisting of wood, carbon fiber, clay, metals, plastics, polymer films, tiles, cellulosic materials, and combinations thereof.

40. The double interpenetrating polymer networks of claim 1, wherein the polymers comprise at least one carrageenan, and at least one alginate or alginic acid.

41. The double interpenetrating polymer networks of claim 40, wherein the carrageenan is κ-carrageenan.
